(19) United States
(12) Patent Application Publication
(10) Pub. No.: US 2015/0251944 A1
(43) Pub. Date: Sep. 10, 2015

(54) METHODS AND APPARATUSES FOR SEPARATING GLASS RIBBONS

(71) Applicant: Corning Incorporated, Corning, NY (US)

(72) Inventors: Douglas Edward Brackley, Horseheads, NY (US); Todd Benson Fleming, Elkland, PA (US); David Joseph Kuhn, Prattsburgh, NY (US); Zhiqiang Shi, Shrewsbury, MA (US); Ningli Yang, Unionville, CT (US); Chester Hann Huei Chang, Painted Post, NY (US)

(21) Appl. No.: 14/638,488

(22) Filed: Mar. 4, 2015

Related U.S. Application Data
(62) Division of application No. 61/950,571, filed on Mar. 10, 2014.

(51) Int. Cl. C03B 33/037; C03B 33/03; B26D 7/32; C03B 33/023

(52) U.S. Cl. CPC C03B 33/037; C03B 33/0235; C03B 33/03; B26D 7/32

(57) ABSTRACT

Apparatus and methods of separating a glass ribbon are provided. In one embodiment, an apparatus for severing glass ribbon includes a plurality of manufacturing components arranged into a travel path, a glass cutting device, and a severing zone positioned in a downstream direction from the glass cutting device, where the severing zone comprising a targeted separation region along the travel path. The apparatus also includes an acoustic transmitter positioned in a first direction from the targeted separation region, an acoustic receiver positioned in a second direction from the targeted separation region opposite the first direction, and a manufacturing component positioned along the travel path in the downstream direction from the targeted separation region.

### CROSS-REFERENCE TO RELATED APPLICATIONS

This application claims the benefit of and priority to U.S. Provisional Application Ser. No. 61/950,571 filed Mar. 10, 2014, the entire disclosure of which is hereby incorporated by reference.

### TECHNICAL FIELD

The present disclosure relates generally to methods of and apparatuses for processing a glass ribbon and, more particularly, to methods of and apparatuses for separating and detecting a glass ribbon that is fed in a continuous stream.

### BACKGROUND

Glass ribbon is known to be used to manufacture various glass products such as LCD sheet glass. Processing of the glass ribbon can be performed with a “roll-to-roll” process where glass ribbon is unwound from an upstream storage roll and then subsequently wound on a downstream storage roll.

### SUMMARY

The following presents a simplified summary of the disclosure in order to provide a basic understanding of some example aspects described in the detailed description.

In a first aspect, an apparatus for severing glass ribbon includes a plurality of manufacturing components arranged into a travel path, a glass cutting device, and a severing zone positioned in a downstream direction from the glass cutting device, where the severing zone comprising a targeted separation region along the travel path. The apparatus also includes an acoustic transmitter positioned in a first direction from the targeted separation region, an acoustic receiver positioned in a second direction from the targeted separation region opposite the first direction, and a manufacturing component positioned along the travel path in the downstream direction from the targeted separation region.

In a second aspect, a method of separating a glass ribbon includes traversing the glass ribbon along a travel path past a glass cutting device and through a severing zone and along a travel direction after exiting the severing zone. The method also includes introducing an acoustic wave into the glass ribbon with an acoustic transmitter positioned in a first direction from the severing zone, detecting a presence of the acoustic wave in the glass ribbon with an acoustic receiver positioned in a second direction from the severing zone that is opposite the first direction, inducing separation of the glass ribbon with the glass cutting device into an upstream portion and a downstream portion, and detecting separation of the glass ribbon in the severing zone when the acoustic wave that was introduced to the glass ribbon is interrupted at the acoustic receiver. The method further includes modifying a conveyance direction of the glass ribbon toward a manufacturing component that is positioned in a downstream direction from the severing zone subsequent to detection of separation of the glass ribbon.

### BRIEF DESCRIPTION OF THE DRAWINGS

These and other aspects are better understood when the following detailed description is read with reference to the accompanying drawings, in which:

FIG. 1 is a schematic illustration of an edge separation apparatus according to one or more embodiments shown or described herein;

FIG. 2 is a schematic illustration of an apparatus for severing a glass ribbon according to one or more embodiments shown or described herein;

FIG. 3 is a sectional view of the edge separation apparatus along line 3-3 of FIG. 1 according to one or more embodiments shown or described herein;

FIG. 4 is a sectional view along line 4-4 of FIG. 2 showing a scribe tip beginning to form a predetermined flaw in the first side of the glass ribbon;

FIG. 5 is a sectional view similar to FIG. 4 after forming the predetermined flaw;

FIG. 6 is an enlarged view of a severing zone of FIG. 2 with a portion of the glass ribbon including a predetermined flaw in a first orientation;

FIG. 7 is a view similar to FIG. 6 with a force being applied to the second side of the glass ribbon to bend a target segment of the glass ribbon;

FIG. 8 is another view similar to FIG. 7 with the predetermined flaw approaching a severing position;

FIG. 9 illustrates the step of severing the central portion of the glass ribbon between opposed edge portions at the predetermined flaw located in the severing zone according to one or more embodiments shown or described herein;

FIG. 10 illustrates the portion of the glass ribbon being returned to the first orientation according to one or more embodiments shown or described herein;

FIG. 11 a schematic illustration demonstrating the step of switching between a first storage roll and a second storage roll according to one or more embodiments shown or described herein according to one or more embodiments shown or described herein;

FIG. 12 is a schematic view of another example apparatus for severing a glass ribbon according to one or more embodiments shown or described herein according to one or more embodiments shown or described herein;

FIG. 13 is a sectional view along line 13-13 of FIG. 12;

FIG. 14 is an enlarged view of the apparatus for severing a glass ribbon from FIG. 12 with the target segment in a first orientation;

FIG. 15 is similar to FIG. 14 with the target segment in a bent orientation;

FIG. 16 is similar to FIG. 15 with the target segment in the bent orientation and the glass ribbon being severed at the predetermined flaw located in the severing zone;

FIG. 17 schematically illustrates a severing zone of the separation apparatus depicting a break detection apparatus according to one or more embodiments shown or described herein;

FIG. 18 schematically illustrates a severing zone of a separation apparatus according to one or more embodiments shown or described herein;

FIG. 19 schematically illustrates an apparatus for severing glass ribbon according to one or more embodiments shown or described herein; and

FIG. 20 schematically illustrates an apparatus for severing glass ribbon according to one or more embodiments shown or described herein.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

Glass may be produced in a generally-continuous forming process to form a glass ribbon. The glass ribbon may be processed through a series of operations by directing the glass ribbon through a corresponding series of processing stations. However, although fabrication of the glass ribbon and subsequent manufacturing processes that work on the glass ribbon are done in a continuous manner, the glass ribbon may be processed and transported in discrete form, including being wound and unwound on spools. Such discrete portions of glass ribbon may, therefore, be processed in roll-to-roll manufacturing processes.

Such forming and manufacturing processes are further described in Co-Pending U.S. application Ser. No. 13/673,385 (Attorney Docket No. SP12-254), titled “Glass Web Separation to Enable Roll to Roll Changeover” and filed on Nov. 9, 2012, the entire disclosure of which is hereby incorporated by reference. The above-referenced application discusses, among other elements, the process to introduce a separation of the continuous glass ribbon and directing the discrete portions of the glass ribbon from a first storage roll to a second storage roll. The discrete portions of glass ribbon are separated from one another, thereby creating a gap between the trailing edge of the completed roll and the leading edge of the upstream glass ribbon line. The gap between the discrete portions of the glass ribbon may prevent glass-to-glass contact during the roll change operation and allow for mechanical equipment to transfer the web onto a new roll. Because glass is a brittle material, glass-to-glass contact may be avoided.

Previous processes have required an operator to observe the cross cut separation to ensure that there is complete separation of the glass ribbon in the separation operation. If there is a separation failure, the operator may interrupt transfer of the glass ribbon from the first storage roll to the second storage roll. The present disclosure is directed to automatic detection of separation of the glass ribbon into discrete glass ribbon portions at the cross cut separation station.

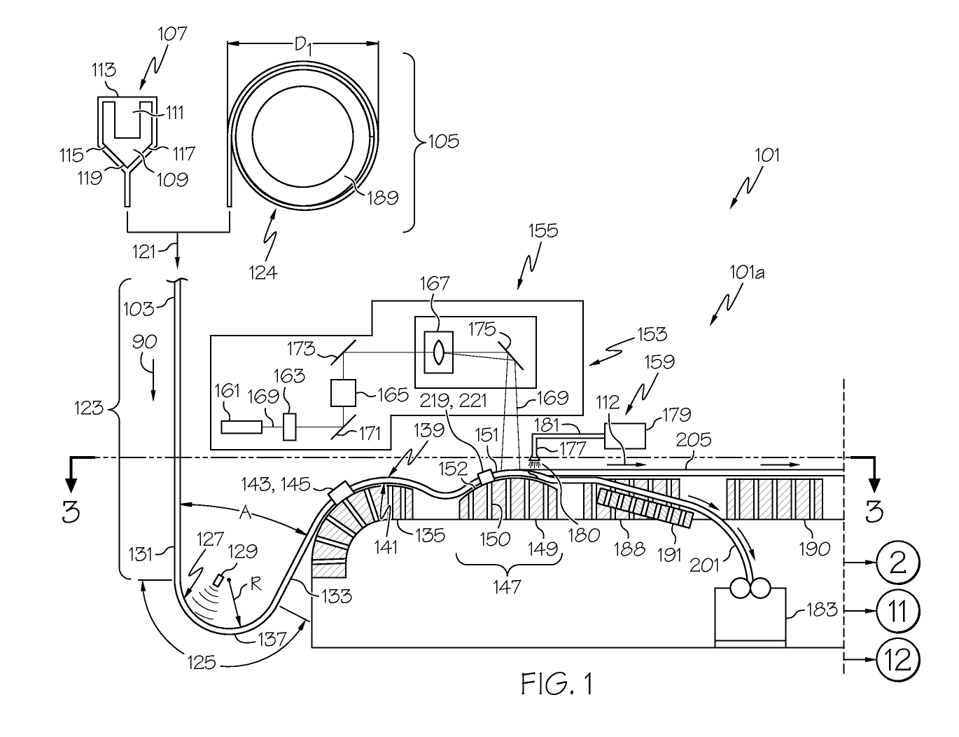

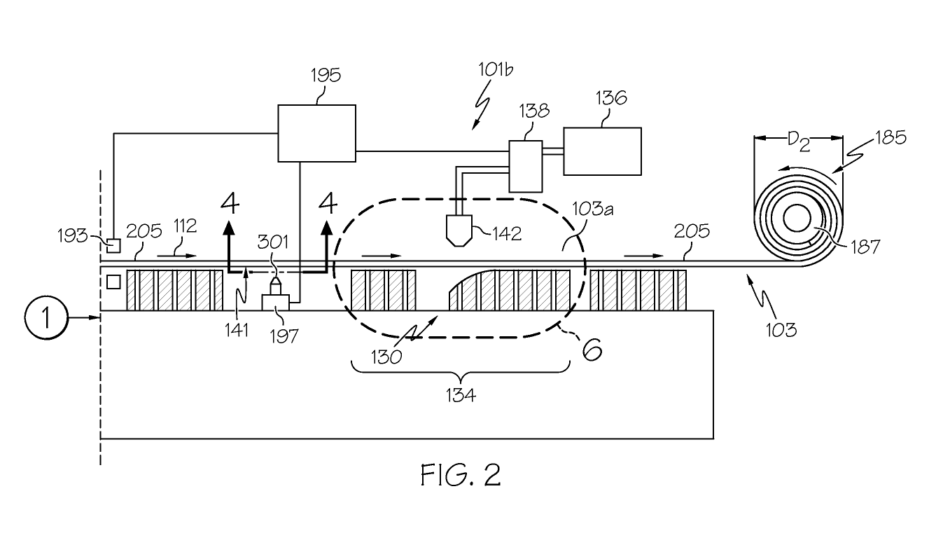

FIGS. 1 and 2 illustrate one example of an apparatus 101 for fabricating a glass ribbon 103. As shown, FIG. 2 is a continuation of FIG. 1, wherein FIGS. 1 and 2 can be read together as the overall configuration of the apparatus 101. The apparatus 101 may include a plurality of manufacturing components that are arranged proximate to one another to perform a sequence of manufacturing operations on the glass ribbon 103 as the glass ribbon 103 is conveyed along the apparatus 101 and through the plurality of manufacturing components. As used herein, “manufacturing component” may refer to any of the substations that are positioned along a travel path 112 of the glass ribbon 103, including, for example, a source 105, a bending zone 125, a glass cutting device 153, support members 404, storage rolls 501,503, and the like, and any component thereof. Examples of the apparatus 101 can include an edge separation apparatus 101a illustrated in FIG. 1 although the edge separation apparatus may be omitted in further examples. In addition or alternatively, as shown in FIG. 2, the apparatus 101 can also include an apparatus 101b for severing a glass ribbon. The edge separation apparatus 101a, for example, may be optionally employed to remove beads or other edge imperfections as described more fully below. Alternatively, the edge separation apparatus 101a may be used to divide the glass ribbon for further processing of the central portion and/or edge portions. The apparatus 101b for severing a glass ribbon can be provided, for example, to help sever a sheet to the desired length, remove an undesirable segment of glass ribbon from the source of glass ribbon, and/or facilitate switching between a first storage roll and a second storage roll with minimal, if any, disruption in traversing of the glass ribbon from the source of glass ribbon.

The glass ribbon 103 for the apparatus 101 can be provided by a wide range of glass ribbon sources. FIG. 1 illustrates two example sources 105 of glass ribbon 103 although other sources may be provided in further examples. For instance, as shown in FIG. 1, the source 105 of glass ribbon 103 can include a down draw glass forming apparatus 107. As schematically shown, the down draw glass forming apparatus 107 can include a forming wedge 109 at the bottom of a trough 111. In operation, molten glass 113 can overflow the trough 111 and flow down opposite converging sides 115, 117 of the forming wedge 109. Converging sides 115, 117 meet at a root 119. The two sheets of molten glass are subsequently fused together as they are drawn off the root 119 of the forming wedge 109. As such, the glass ribbon 103 may be fusion down drawn to traverse in a downward direction 121 off the root 119 of the forming wedge 109 and directly into a downward zone 123 positioned downstream from the down draw glass forming apparatus 107. The direction that the glass ribbon 103 is drawn away from the down draw glass forming apparatus 107 defines a downstream direction 90 of the apparatus 101, and upstream and downstream orientation of components of the apparatus 101. Other down draw forming methods for the glass ribbon source 105, such as slot draw, are also possible. Regardless of the source or method of production, the glass ribbon 103 can possibly have a thickness of ≦500 microns, ≦300 microns, ≦200 microns, or ≦100 microns. In one example, the glass ribbon 103 can include a thickness of from about 50 microns to about 300 microns, for example 50, 60, 80, 100, 125, 150, 175, 200, 225, 250, 260, 270, 280, 290, or 300 microns, although other thicknesses may be provided in further examples. The glass ribbon 103 can possibly have a width of ≧20 mm, ≧50 mm, ≧100 mm, ≧500 mm, or ≧1000 mm. The glass ribbon 103 can possibly have a variety of compositions including but not limited to soda-lime, borosilicate, alumino-borosilicate, alkali-containing, or alkali-free. The glass ribbon 103 can possibly have a coefficient of thermal expansion of ≦15 ppm/° C., ≦10 ppm/° C., or ≦5 ppm/° C. The glass ribbon 103 can possibly have a speed as it traverses along travel path 112 of ≧50 mm/s, ≧100 mm/s, or ≧500 mm/s.

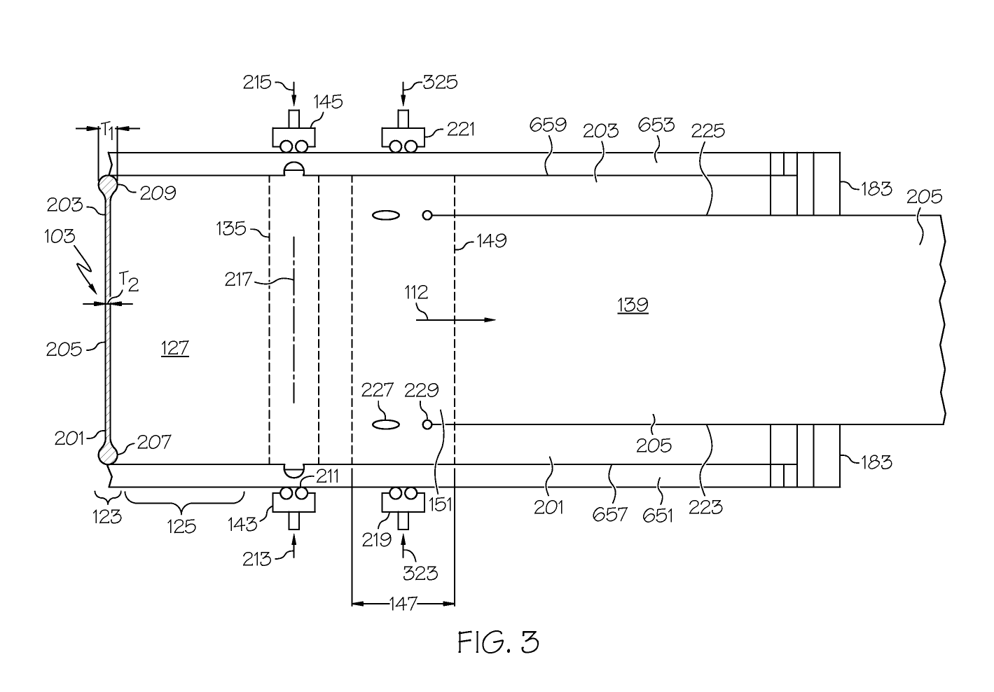

As shown by the cross section of FIG. 3, the glass ribbon 103 may include a pair of opposed edge portions 201, 203 and a central portion 205 spanning between the opposed edge portions 201, 203. Due to the down draw fusion process, the edge portions 201, 203 of the glass ribbon may have corresponding beads 207, 209 with a thickness “T₁” that is greater than a thickness “T₂” of the central portion 205 of the glass ribbon 103. The apparatus 101 can be designed to process glass ribbons 103 with a thin central portion 205, such as glass ribbons with a thickness “T₂” in a range of from about 20 microns to about 300 microns (e.g., 20, 30, 40, 50, 60, 70, 80, 90, 100, 110, 120, 130, 140, 150, 170, 190, 210, 230, 250, 260, 270, 280, 290, or 300 microns, for example), such as from about 50 microns to about 300 microns, such as from about 85 microns to about 150 microns although glass ribbons with other thicknesses may be processed in further examples. In addition or alternatively to what is shown in FIG. 3, the edge beads 207, 209 may have non-circular shapes such as elliptical, oblong, rectangular, or other shapes with convex or other features.

Referring again to FIG. 1, another example source 105 of glass ribbon 103 may include a coiled roll 124 of glass ribbon 103. For example, glass ribbon 103 may be wound into the coiled roll 124 after being drawn into a glass ribbon, for example, with the down draw glass forming apparatus 107. The glass ribbon 103 rolled or coiled on the coiled roll 124 may or may not have the illustrated edge portions 201, 203. However, if the greater thickness of the edge portions 201, 203 are present, they may increase the minimum bend radius required to avoid cracking or breaking the glass ribbon. As such, if coiled, the glass ribbon 103 may be coiled with a relatively large bend radius such that a given length of glass ribbon 103 would require a coiled roll 124 with a relatively large diameter “D₁”. Thus, if the source 105 includes the coiled roll 124, the glass ribbon 103 may be uncoiled from the coiled roll 124 of glass ribbon 103 to traverse the glass ribbon 103 in the downward direction 121 into the downward zone 123.

FIGS. 1 and 2 illustrate aspects of just one example edge separation apparatus 101a that may be optionally included although, if provided, other edge separation apparatus may be incorporated in further examples. As shown in FIG. 1, the optional edge separation apparatus can include a bending zone 125 that is positioned in a downstream direction 90 from the downward zone 123. In the bending zone 125, the edge separation apparatus 101a can be designed to permit the glass ribbon 103 to travel through a curved path such that an upper surface 127 of the glass ribbon 103 includes an upwardly concave surface as the ribbon bends through a radius “R” within the bending zone 125. The radius “R” may be greater than a minimum bend radius of the glass ribbon 103 to avoid excessive stress concentrations in the glass ribbon 103. The glass ribbon 103 may extend through various arcs within the bending zone 125 such that a pre-bending portion 131 of the glass ribbon 103 entering the bending zone 125 can extend at various angles with respect to a post-bending portion 133 of the glass ribbon 103. For example, as shown in FIG. 1, the angle “A” between the pre-bending portion 131 and the post-bending portion 133 can include an acute angle although angles of 90° or more may be provided in further examples while still providing the upwardly concave surface 127.

The edge separation apparatus 101a can further include an optional bending support member 135 in examples where the elevation of a lower portion 137 of the glass ribbon within the bending zone 125 is lower than a lateral travel elevation of the glass ribbon passing through support portions leading to a severing zone 147. The bending support member 135, if provided, can include a non-contact support member designed to support the glass ribbon 103 without touching the opposed first and second sides 141, 139 of the central portion 205 of the glass ribbon 103. For example, the bending support member 135 can include one or more curved air bars configured to provide a cushion of air to space the glass ribbon from contacting the bending support member 135.

Examples of the edge separation apparatus 101a can include lateral guides 143, 145 to help orient the glass ribbon 103 in the correct lateral position relative to a travel path 112 of the glass ribbon 103. For example, as schematically shown in FIG. 3, the lateral guides can each include rollers 211 configured to engage a corresponding one of the opposed edge portions 201, 203, or if provided, corresponding handling tabs 651, 653. Handling tabs 651, 653 may be, for example, a polymeric tape applied to the edge portions. Corresponding forces 213, 215 applied to the edge portions 201, 203 by the corresponding lateral guides 143, 145 can help properly shift and align the glass ribbon 103 in the proper lateral orientation along a direction of an axis 217 transverse to the travel path 112 of the glass ribbon 103. The severing zone produces an edge quality that possibly enables the central portion 205 to be bent at a radius of ≦500 mm, ≦300 mm, ≦200 mm, ≦100 mm, or ≦50 mm.

As further illustrated, the lateral guides 143, 145 can be designed to engage the edge portions 201, 203, or corresponding handling tabs 651, 653, without engaging the central portion 205 of the glass ribbon 103. As such, the pristine surfaces of the opposed sides 139, 141 of the central portion 205 of the glass ribbon 103 can be maintained while avoiding undesired scratching or other surface contamination that might otherwise occur if the lateral guides 143, 145 were to engage either of the opposed first and second sides 141, 139 of the central portion 205 of the glass ribbon 103. Engagement on the edge portions 201, 203, or corresponding handling tabs 651, 653, also prevents damage or contamination to opposed edges 223, 225 of the central portion 205 which could degrade the strength of central portion 205 and increase the probability of breakage when central portion 205 is bent such as when rolled onto storage roll 185. Moreover, the lateral guides 143, 145 may engage the glass ribbon 103 as it is being bent about the axis 217 transverse to the travel path 112 of the glass ribbon 103. Bending the glass ribbon 103 over the bending support member 135 can increase the rigidity of the glass ribbon 103 throughout the bend. As such, the lateral guides 143, 145 can apply lateral forces to the glass ribbon 103 in a bent condition as the glass ribbon 103 passes over the bending support member 135. The forces 213, 215 applied by the lateral guides 143, 145 are therefore less likely to buckle or otherwise disturb the stability of the glass ribbon profile when laterally aligning as the glass ribbon 103 passes over the bending support member 135.

The edge separation apparatus can further include a severing zone 147 that is positioned in a downstream direction from the bending zone 125. In one example, the edge separation apparatus 101a may include a cutting support member 149 configured to bend the glass ribbon 103 in the severing zone 147 to provide a bent target segment 151 with a bent orientation in the severing zone 147. Bending the target segment 151 within the severing zone 147 can help stabilize the glass ribbon 103 during the cutting procedure. Such stabilization can help prevent buckling or disturbing the glass ribbon profile during the procedure of severing at least one of the opposed edge portions 201, 203 from the central portion 205 of the glass ribbon 103. The severing zone produces an edge quality that possibly enables the central portion 205 to be bent at a radius of ≦500 mm, ≦300 mm, ≦200 mm, ≦100 mm, or ≦50 mm.

The cutting support member 149, if provided, can include a non-contact cutting support member 149 designed to support the glass ribbon 103 without touching the opposed sides 139, 141 of the glass ribbon 103. For example, the non-contact cutting support member 149 can include one or more curved air bars configured to provide a cushion of air space between the glass ribbon 103 and the cutting support member 149 to prevent the central portion 205 of the glass ribbon 103 from contacting the cutting support member 149.

In one example, the cutting support member 149 can be provided with a plurality of passages 150 configured to provide positive pressure ports such that an air stream can be forced through the positive pressure ports toward the bent target segment 151 to create an air cushion for a noncontact support of the bent target segment 151. Optionally, the plurality of passages 150 can include negative pressure ports such that an air stream can be drawn away from the bent target segment 151 to create a suction to partially counteract the force from the air cushion created by the positive pressure ports. A combination of positive and negative pressure ports can help stabilize the bent target segment 151 throughout the cutting procedure. Indeed, the positive pressure ports can help maintain a desired air cushion height between the central portion 205 of the glass ribbon 103 and the cutting support member 149. At the same time, the negative pressure ports can help pull the glass ribbon toward the cutting support member 149 to prevent the glass ribbon 103 from undulating and/or prevent portions of the bent target segment 151 from floating away when traversing over the cutting support member 149 in the travel path 112.

Providing a bent target segment 151 in the severing zone 147 can also increase the rigidity of the glass ribbon 103 throughout the severing zone 147. Increasing the rigidity of the glass ribbon 103 throughout the severing zone 147 can help reduce changes in orientation due to natural shape variation of the incoming glass ribbon 103 which can produce undesirable variation in the cutting process. Increasing the rigidity of the glass ribbon 103 throughout the severing zone 147 can also reduce the impact of mechanical perturbations and vibrations on the cutting process. Also, as shown in FIG. 3, optional lateral guides 219, 221 can apply lateral forces to the glass ribbon 103 in a bent condition as the glass ribbon 103 passes over the cutting support member 149 within the severing zone 147. Forces 323, 325 applied by the lateral guides 219, 221 are therefore less likely to buckle or otherwise disturb the stability of the glass ribbon profile when laterally aligning as the glass ribbon 103 passes over the cutting support member 149. The optional lateral guides 219, 221 can therefore be provided to fine tune the bent target segment 151 at the proper lateral orientation along a direction of the axis 217 transverse to the travel path 112 of the glass ribbon 103.

As set forth above, providing the bent target segment 151 in a bent orientation within the severing zone 147 can help stabilize the glass ribbon 103 during the cutting procedure. Such stabilization can help prevent buckling or disturbing the glass ribbon profile during the procedure of severing at least one of the opposed edge portions 201, 203. Moreover, the bent orientation of the bent target segment 151 can increase the rigidity of the target segment to allow optional fine tune adjustment of the lateral orientation of the bent target segment 151. As such, relatively thin glass ribbons 103 can be effectively stabilized and properly laterally oriented without contacting the pristine opposed first and second sides 141, 139 of the central portion 205 of the glass ribbon 103 during the procedure of severing at least one of the opposed edge portions 201, 203 from the central portion 205 of the glass ribbon 103.

Increased stabilization and rigidity of the bent target segment 151 of the glass ribbon 103 can be achieved by bending the target segment to include an upwardly convex surface and/or an upwardly concave surface along a direction of the axis 217 transverse to the travel path 112. For example, as shown in FIG. 1, the bent target segment 151 includes a bent orientation with an upwardly facing convex surface 152 configured to bend the glass ribbon 103 in the severing zone 147 to achieve the illustrated bent orientation. Although not shown, further examples may include supporting the target segment 151 with an upwardly facing concave surface configured to allow the bent target segment to achieve an upwardly facing concave surface.

The edge separation apparatus 101a can further include a wide range of cutting devices configured to sever the edge portions 201, 203 from the central portion 205 of the glass ribbon 103. In one example, as shown in FIG. 1, one example glass cutting device 153 can include an optical delivery apparatus 155 for irradiating and therefore heating a portion of the upwardly facing surface of the bent target segment 151. In one example, optical delivery apparatus 155 can include a radiation source such as the illustrated laser 161 although other radiation sources may be provided in further examples. The optical delivery apparatus 155 can further include a circular polarizer 163, a beam expander 165, and a beam shaping apparatus 167.

The optical delivery apparatus 155 may further include optical elements for redirecting a beam of radiation (e.g., laser beam 169) from the radiation source (e.g., laser 161), such as mirrors 171, 173 and 175. The radiation source can include the illustrated laser 161 configured to emit a laser beam having a wavelength and a power suitable for heating the glass ribbon 103 at a location where the beam is incident on the glass ribbon 103. In one embodiment, laser 161 can include a CO₂ laser although other laser types may be used in further examples.

The laser 161 may be configured to initially emit the laser beam 169 with a substantially circular cross section (i.e. the cross section of the laser beam at right angles to the longitudinal axis of the laser beam). The optical delivery apparatus 155 is operable to transform laser beam 169 such that the beam has a significantly elongated shape when incident on glass ribbon 103. As shown in FIG. 3, the elongated shape can produce an elongated radiation zone 227 that may include the illustrated elliptical footprint although other configurations may be provided in further examples. The elliptical foot print can be positioned on the upwardly facing convex or concave surface of the bent target segment 151. Heat from the elongated radiation zone 227 can transmit through the entire thickness of the glass ribbon 103.

The boundary of the elliptical footprint can be determined as the point at which the beam intensity has been reduced to 1/e² of its peak value, wherein “e” is the base of the natural logarithm. The laser beam 169 passes through circular polarizer 163 and is then expanded by passing through beam expander 165. The expanded laser beam then passes through beam shaping apparatus 167 to form a beam producing the elliptical footprint on a surface of the bent target segment 151. The beam shaping apparatus 167 may, for example, include one or more cylindrical lenses. However, it should be understood that any optical elements capable of shaping the beam emitted by laser 161 to produce an elliptical footprint on the bent target segment 151 may be used.

The elliptical footprint can include a major axis that is substantially longer than a minor axis. In some embodiments, for example, the major axis is at least about ten times longer than the minor axis. However, the length and width of the elongated radiation zone are dependent upon the desired severing speed, desired initial defect size, thickness of the glass ribbon, laser power, material properties of the glass ribbon, etc., and the length and width of the radiation zone may be varied as needed.

As further shown in FIG. 1, the example glass cutting device 153 can also include a coolant fluid delivery apparatus 159 configured to cool the heated portion of the upwardly facing surface of the bent target segment 151. The coolant fluid delivery apparatus 159 can include a coolant nozzle 177, a coolant source 179 and an associated conduit 181 that may convey coolant to the coolant nozzle 177. As shown in FIG. 1, the forced fluid cooling can occur on the same side of the glass as the incident heating source. As shown, the forced fluid cooling and incident heating sources can be applied to the upper surface of the glass, although they can both be applied to the lower surface in further examples. Still further, the heat source and cooling source can be incident on opposite surfaces of the glass ribbon. For example, one of the forced fluid cooling source and the heating source can be positioned to act on an upper surface of the ribbon while the other of the forced fluid cooling source and the heating source acts on the lower surface of the ribbon. In such a configuration, the oppositely located cooling and heating sources can be counter-propagating.

With reference to FIG. 1, the coolant nozzle 177 can be configured to deliver a coolant jet 180 of coolant fluid to the upwardly facing surface of the bent target segment 151. The coolant nozzle 177 can have various internal diameters to form a cooling zone 229 (see FIG. 3) of a desired size. As with elongated radiation zone 227, the diameter of coolant nozzle 177, and the subsequent diameter of coolant jet 180, may be varied as needed for the particular process conditions. In some embodiments, the area of the glass ribbon immediately impinged upon by the coolant (cooling zone) can have a diameter shorter than the minor axis of the radiation zone 227. However, in certain other embodiments, the diameter of the cooling zone 229 may be larger than the minor axis of elongated radiation zone 227 based on process conditions such as speed, glass thickness, material properties of the glass ribbon, laser power, etc. Indeed, the (cross sectional) shape of the coolant jet may be other than circular, and may, for example, have a fan shape such that the cooling zone forms a line rather than a circular spot on the surface of the glass ribbon. A line-shaped cooling zone may be oriented, for example, perpendicular to the major axis of elongated radiation zone 227. Other shapes may be beneficial.

In one example, the coolant jet 180 includes water, but may be any suitable cooling fluid (e.g., liquid jet, gas jet or a combination thereof) that does not permanently stain or damage the upwardly facing surface of the bent target segment 151 of the glass ribbon 103. The coolant jet 180 can be delivered to a surface of the glass ribbon 103 to form the cooling zone 229. As shown, the cooling zone 229 can trail behind the elongated radiation zone 227 to propagate an initial defect formed by aspects of the disclosure described more fully below.

Although not shown, in some configurations coolant fluid delivery apparatus 159 may not be required to perform the cutting operation. For example, heat transfer to the environment (e.g., air flowing through the support member 149 and natural convection of the moving web) may provide all the cooling that is required to sustain the cutting process without the presence or operation of the coolant fluid delivery apparatus 159.

The combination of heating and cooling with the optical delivery apparatus 155 and the coolant fluid delivery apparatus 159 can effectively sever the edge portions 201, 203 from the central portion 205 while minimizing or eliminating undesired residual stress, microcracks or other irregularities in the opposed edges 223, 225 of the central portion 205 that may be formed by other severing techniques. Moreover, due to the bent orientation of the bent target segment 151 within the severing zone 147, the glass ribbon 103 can be properly positioned and stabilized to facilitate precise severing of the opposed edges 223, 225 during the severing process. Still further, due to the convex surface topography of the upwardly facing convex support surface, the edge portions 201, 203 can immediately travel away from the central portion 205, thereby reducing the probability that the edge portions will subsequently engage (and therefore damage) the pristine first and second sides 141, 139 and/or the high quality opposed edges 223, 225 of the central portion 205. As shown in FIG. 1, two curved support members 135, 149 may be provided. In further examples, a single curved support member may be provided, thereby eliminating the need for a second curved support member.

Referring again to FIG. 1, the edge separation apparatus 101a may include structures configured to further process the severed edge portions 201, 203 and/or the central portion 205 of the glass ribbon 103 that is positioned in a downstream direction from the severing zone 147. For example, one or more glass ribbon choppers 183 may be provided to chop, shred, break or otherwise compact the trim segments for disposal or recycling.

The central portion 205 of the glass ribbon 103 can be further processed by cutting into glass sheets for incorporation into optical components. For example, the apparatus 101 may include the apparatus 101b for severing a glass ribbon described more fully below to sever the central portion 205 of the glass ribbon 103 along the axis 217 transverse to the travel path 112 of the glass ribbon 103. In addition, or alternative to the apparatus 101b for severing a glass ribbon, the central portion 205 of the glass ribbon 103 can be coiled into a storage roll 185 for later processing. As shown, removing the edge portions 201, 203 consequently removes the corresponding beads 207, 209. Removing the beads reduces the minimum bend radius to allow the central portion 205 of the glass ribbon 103 to be more efficiently wound into a storage roll 185. As represented in FIG. 2, the central core 187 of the storage roll 185 is significantly reduced when compared to the central core 189 of the coiled roll 124. As such, the diameter “D₂” of the storage roll 185 of the central portion 205 is significantly smaller than the diameter “D₁” that would store the same length of pre-processed glass ribbon in the coiled roll 124.

Still further shown in FIG. 1, the edge separation apparatus 101a may also include further noncontact support members to guide at least the central portion 205 of the glass ribbon 103 downstream from the severing zone 147. For example, as shown, the apparatus can include a first air bar 188 and a second air bar 190 to guide the central portion 205 of the glass ribbon for final processing without contacting the surfaces. Two support members are illustrated although a single support member or more than two support members may be provided in further examples. As further shown, an optional support member 191 can also be provided to allow the edge portion to be guided to the glass ribbon chopper 183. The optional support member 191 can optionally include an air bar or low friction surface to reduce binding and/or restricted movement as the edge portion proceeds to the glass ribbon choppers 183.

In some examples, the glass ribbon 103 may also travel directly from the source 105 of glass ribbon to an apparatus 101b for severing the glass ribbon 103. Alternatively, as shown, the edge separation apparatus 101a may optionally remove edge portions of the glass ribbon 103 at a location upstream. Subsequently, the central portion 205 of the glass ribbon 103 can travel with respect to the apparatus 101b for eventual final processing of the glass ribbon. In some examples, the glass ribbon can be severed into appropriate severed lengths. In further examples, an undesired segment (e.g., segment of low quality) can be removed from the otherwise continuous length of high quality glass ribbon. In still further examples, the glass ribbon can be stored on the illustrated storage roll 185. In one example, the apparatus 101b for severing the glass ribbon 103 can be used to switch between a full storage roll and a new storage roll without interrupting movement of the glass ribbon along travel path 112.

FIG. 2 illustrates just one example of an apparatus 101b that may be used to selectively sever the glass ribbon 103 although other apparatus may be used in further examples. As shown in FIG. 2, the apparatus 101b may include a monitoring device 193 that may sense a characteristic of the glass ribbon 103 and send back a corresponding signal to an electronic controller 195. Characteristics can include, but are not limited to, optical quality, inclusions, cracks, inhomogeneous features, thickness, color, surface flatness or imperfections, and/or other features. In one example, the monitoring device 193 may include a quality control device configured to screen the glass ribbon, either continuously or periodically, in an effort to ensure a high quality glass ribbon passing to be stored or further processed.

As further illustrated, the apparatus 101b may further include a device 197 configured to generate a predetermined flaw in the first side 141 of the glass ribbon 103. In one example, the device 197 can include the illustrated mechanical scoring device wherein a relatively sharp tip 301 may be used to score the first side 141 of the glass ribbon 103. In further examples, the device 197 can include a laser or other device configured to introduce the predetermined flaw at the edge, side surface, or within a portion along the width of the glass ribbon 103.

As further illustrated in FIG. 6, the apparatus 101b may optionally include a support member 130 configured to emit fluid 132 to impact the first side 141 of the glass ribbon 103 to at least partially support a weight of a portion 103a of the glass ribbon 103 within a severing zone 134 while maintaining the portion 103a of the glass ribbon 103 in a first orientation. As shown, the first orientation can include a substantially flat orientation that runs along the travel path 112 although the first orientation may be curved or form other travel paths in further examples.

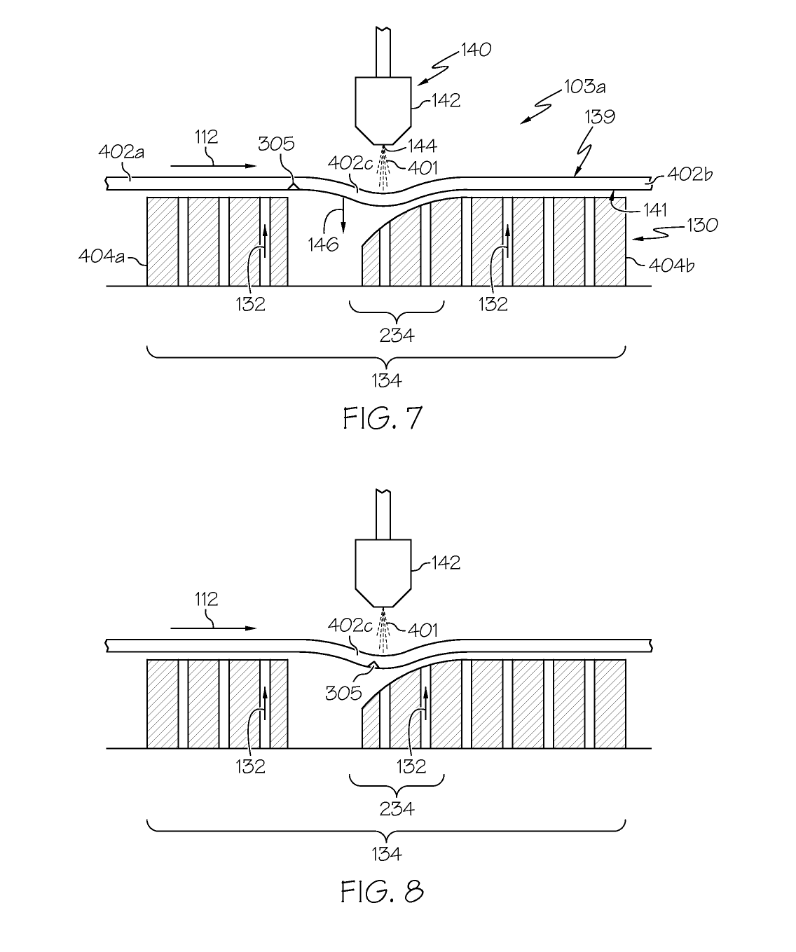

Examples of the apparatus 101b for severing the glass ribbon 103 can further include a device 140 configured to temporarily bend the portion 103a of the glass ribbon 103 in a direction 146 toward the support member from the first orientation (e.g., shown in FIG. 6) to a severing orientation (e.g., shown in FIGS. 7 and 8) by applying a force to the second side 139 of the glass ribbon 103. The device 140 for temporarily bending the portion 103a of the glass ribbon 103 can include a wide range of structures with various configurations.

FIG. 6 illustrates just one device 140 that may be used to temporarily bend the portion 103a of the glass ribbon 103. The example device 140 may include a fluid nozzle 142. As schematically shown in FIG. 5, the fluid nozzle 142 may extend along substantially the entire width of the glass ribbon 103. Furthermore, as shown, the nozzle 142 may have a width that is substantially greater than the width of the glass ribbon 103. The nozzle 142, if provided, can be a continuous nozzle and/or a plurality of nozzles spaced apart from one another in a row across the width of the glass ribbon.

The nozzle 142 can include an orifice 144 designed to emit fluid, such as gas, to impact the second side 139 of the glass ribbon 103 within the severing zone 134. As shown in FIG. 2, the nozzle 142 can received pressurized fluid, such as gas, from a fluid source 136 by way of a fluid manifold 138 configured to be controlled by the electronic controller 195. The pressurized fluid may induce stress into the glass ribbon 103 due to the thermal profile across the thickness of the glass ribbon 103. The sub-region of the severing zone 134 in which such a stress is induced into the glass ribbon 103, and therefore, the sub-region at which the glass ribbon 103 may be likely to be severed is referred to as the targeted separation region 234.

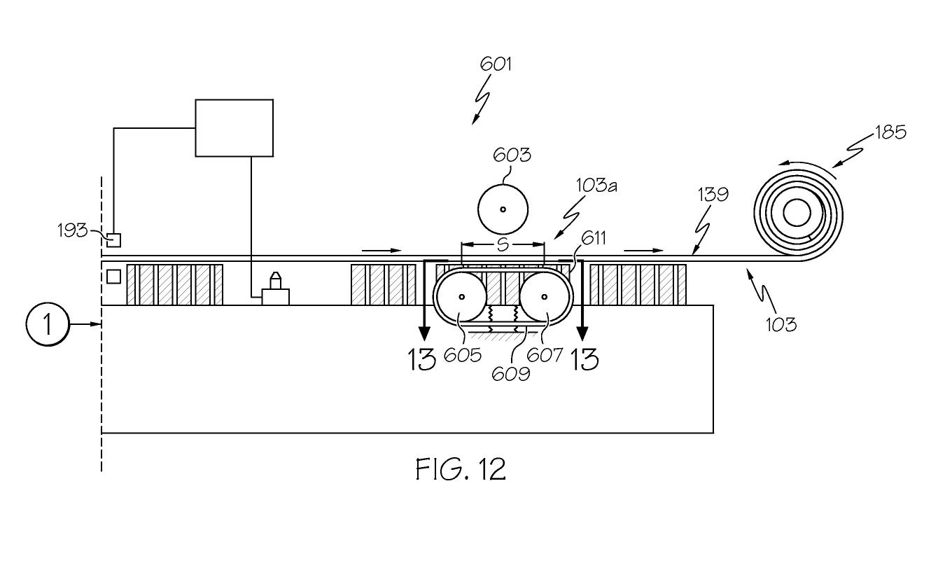

FIG. 12 illustrates yet another example of a contact apparatus 601 for severing the glass ribbon 103. The contact apparatus 601 can include at least a first roller 603 configured to apply a force to the second side 139 of the glass ribbon 103. The contact apparatus 601 can further include a second roller 605 and a third roller 607 spaced from the second roller along a support width “S.” The first roller 603 applies the force to the second side 139 of the glass ribbon 103 along the support width “S” defined between the second roller 605 and the third roller 607. Optionally, an endless belt 609 can be configured to rotate with the second roller 605 and the third roller 607. For example, the endless belt 609 can be mounted with the second roller 605 acting as one end roller and the third roller 607 acting as the second end roller, wherein the rollers can be biased away from each other to help maintain the endless belt 609 in tension.

As further shown in FIG. 12, the contact apparatus 601 can include a support member 611 that may support the portion 103a of the glass ribbon in the first orientation shown in FIG. 12. In one example, the support member can include passages to transfer fluid, such as gas, through the passages to support the portion 103a of the glass ribbon with a liquid (e.g., gas) cushion generated between the first side 141 and the support member 611.

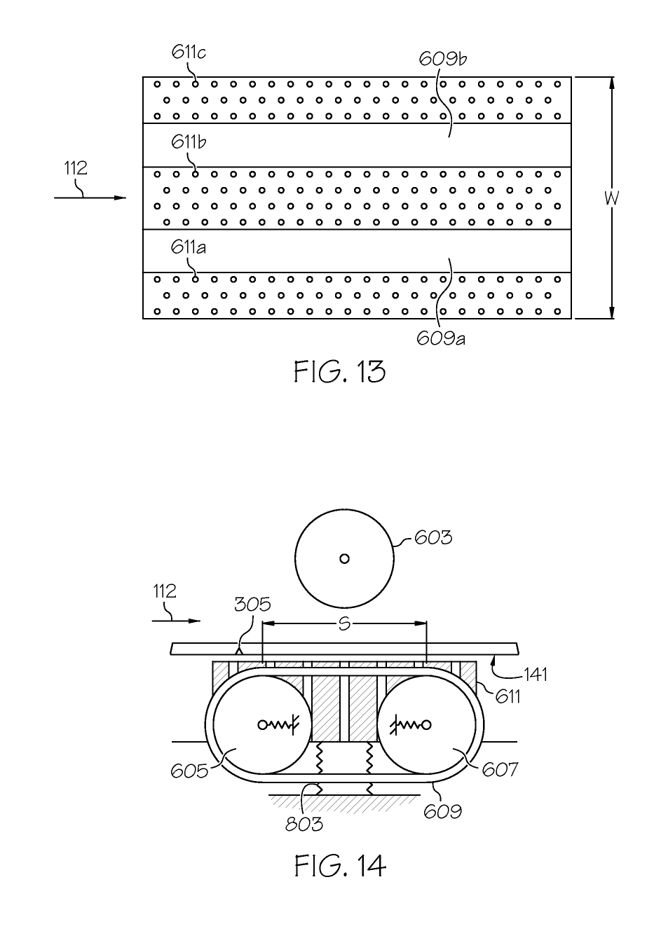

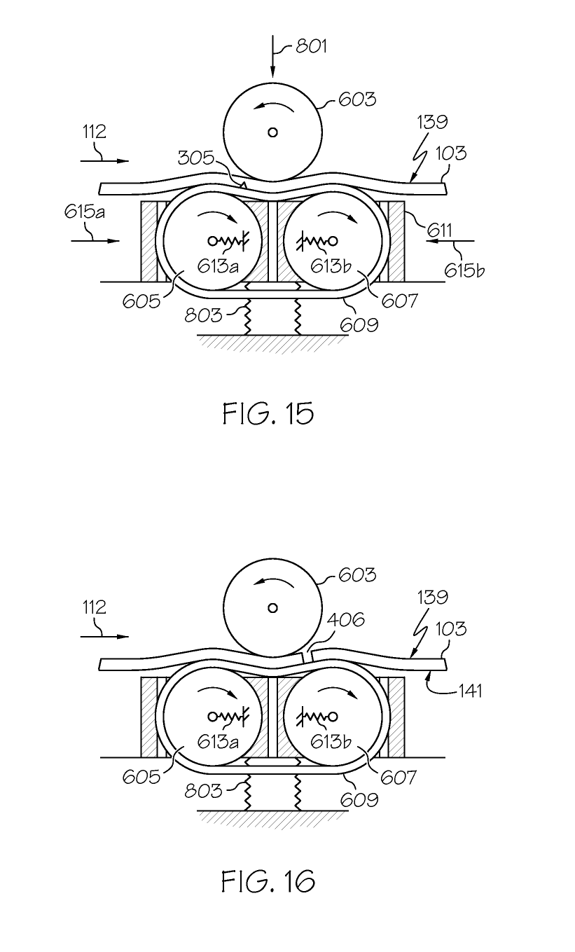

In one example, there may be a plurality of support members 611 offset relative to one another along the width “W” of the support member extending transverse to the travel path 112. For example, as shown in FIG. 13, the support member 611 includes three spaced support members 611a, 611b, 611c spaced from one another. Likewise, in such examples, a plurality of endless belts may be provided between each of the spaced support members. For example, as shown in FIG. 13, the endless belt 609 includes a first endless belt 609a positioned between adjacent support members 611a, 611b and a second endless belt 609b positioned between adjacent support members 611b, 611c. As such, the portion 103a of the glass ribbon 103 may be adequately supported in the first orientation shown in FIGS. 12 and 14 (i.e., by the fluid cushion) and the bent orientation shown in FIGS. 15 and 16.

In yet another example, the apparatus for severing the glass ribbon may include an apparatus similar to FIGS. 6-10 but include at least one roller, rather than the fluid nozzle 142, configured to apply the force to the second side of the glass ribbon. In such an example, the roller (e.g., similar to the first roller 603 discussed above) can rotate while temporarily bending the portion of the glass ribbon in the direction toward the support member. As such, rather than the non-contact fluid nozzle 142, a contact roller may be provided that temporarily bends the portion of the glass ribbon in the direction toward the support member similar to that shown in FIGS. 7-9. At the same time, as shown in FIGS. 7-9 upstream and downstream support members can provide a contact-free support of the first side of the glass ribbon with corresponding fluid cushions provided by the support members.

As described above, the glass ribbon 103 can be severed by any number of means. After the glass ribbon 103 is severed as shown in FIG. 11, the glass ribbon is separated into an upstream web 631 and a downstream web 633. The upstream web 631 includes an upstream edge portion 635 including an upstream severed edge 637. The downstream web 633 includes a downstream edge portion 639 including a downstream severed edge 641. It can be advantageous to create a gap 683 between the upstream web 631 and the downstream web 633. The gap 683 can help facilitate modifying a conveyance direction of the glass ribbon 103 toward the first storage roll 501 to a second storage roll 503 (or vice versa) without changing the process speed of the apparatus 101. The glass ribbon 103 may therefore be directed along a first exiting travel path 112a toward the first storage roll 501 or, alternatively, directed along a second exiting travel path 112b toward the second storage roll 503 without disturbing upstream processes of the apparatus 101. Additionally, the gap 683 can also help reduce or eliminate damage to the glass ribbon 103 created by glass-to-glass contact between the downstream severed edge 641 and the upstream severed edge 637.

In one example, the gap 683 between the downstream severed edge 641 and the upstream severed edge 637 can facilitate ease of transfer of glass ribbon 103 flow from a first storage roll 501 to a second storage roll 503 by modifying the exit travel path of the glass ribbon through a steering element 405, as seen in FIG. 11. As shown, the downstream web 633 is wound on the first storage roll 501. A sensor 509 can detect the gap 683 and communicate the existence of the gap to the electronic controller 195. The electronic controller 195 can then initiate a path change for the upstream web 631. In one example, the upstream web can then be guided toward the second storage roll 503 between a second storage roll support 404c and a first storage roll support 404d. The upstream edge portion 635 of the upstream web 631 is introduced to the second storage roll 503 to begin winding the upstream web 631 on the second storage roll 503. It is to be appreciated that any method of changing the flow of the upstream web 631 to the second storage roll 503 can be used. As the second storage roll 503 reaches capacity, the steps can be repeated to introduce the following severed glass web section to the first storage roll 501.

Processing glass substrates in sheet or roll form can include the use of a handling tabs 651, 653 (e.g., see FIG. 3) located on the glass ribbon 103 to aid in various processing steps. The handling tabs 651, 653 may be provided on the edge portions 201, 203. For instance, the handling tabs 651, 653 may have been previously applied and rolled into the coiled roll 124. Such handling tabs 651, 653 may be provided, for example to help align the glass ribbon in the coiled roll 124 and help space the pristine surfaces of the glass ribbon wound in the coiled roll 124. FIG. 3 schematically illustrates the handling tabs 651, 653 adjacent the beads 207, 209 for illustration purposes. While the handling tabs 651, 653 may be provided on the beads, in addition or alternatively, the handling tabs may also be provided on the opposed edges 223, 225 of the central portion 205 of the glass ribbon 103 after the edge portions 201, 203 have been removed.

If provided, handling tabs 651, 653 can be placed on the glass ribbon to help reduce physical damage to the glass ribbon during handling. In another example, the handling tabs 651, 653 can help align layers of glass ribbon 103 within storage rolls 501, 503 (e.g., see FIG. 11) so that the edges of the roll remain aligned with respect to one another while spacing the pristine surfaces of the glass ribbon from one another as the glass ribbon 103 is rolled. In yet another example, the handling tabs 651, 653 can be configured to permit glass ribbon 103 location and manipulation without physical contact of one layer of the glass ribbon 103 with an adjacent layer of the glass ribbon within the storage roll 501, 503. Furthermore, the handling tabs 651, 653 can be removable.

As shown in FIG. 3 and mentioned previously, the handling tabs 651, 653 can be applied to the glass ribbon 103 prior to the optional step of edge separation. In addition or alternatively, the handling tabs 651, 653 can be applied to the glass ribbon 103 after the optional edge separation. In another example, the handling tabs 651, 653 can be applied to the glass ribbon 103 prior to being wound about glass ribbon source 105 (e.g., FIG. 1), remain applied to the glass ribbon through the glass ribbon severing process, and then be wound with the glass ribbon onto a storage roll 501, 503. In another example, the handling tabs 651, 653 can be applied to the upstream web 631 and the downstream web 633 after the glass ribbon has been severed. FIG. 25 illustrates a handling tab 651 attached to a first side edge 657 and a handling tab 653 attached to a second side edge 659. Further examples can include only one of the handling tabs 651, 653 attached to one of the first side edge 657 or the second side edge 659.

FIG. 25 shows one example of handling tabs 651, 653 located on the glass ribbon 103. Handling tab 651 is shown attached to the first side edge 657 and handling tab 653 is shown attached to the second side edge 659. Each of the handling tabs 651, 653 can include apertures 661 open at an interior edge of the handling tab to expose the entire width of the glass ribbon 103 across its width, i.e., parallel to the direction of axis 217, which can be substantially perpendicular to the travel path 112 of the glass ribbon 103. Each of the apertures 661 can extend only partially across the handling tabs 651, 653, so that at least a portion of the handling tabs 651, 653 is continuous along the glass ribbon 103. The apertures 661 can be said to resemble “mouse holes” in their appearance with an opening at an interior edge of the handling tab to effectively reduce the transverse width of the tab across the apertures 661 to expose a target area 663. As previously described, the handling tabs 651, 653 can be applied to the upstream web 631 and the downstream web 633 after the glass ribbon has been severed. In this case, the apertures 661 are aligned with the sever line or resulting gap between the upstream web 631 and the downstream web 633. In another example, the handling tabs 651, 653 can be applied to the glass ribbon 103 prior to the severing operation. In this case, the apertures 661 allow the glass ribbon 103 to be severed across its entire width (e.g. in the target area 663) while maintaining a physical connection between the individual severed pieces of the glass ribbon 103. The handling tabs 651, 653 can be removed entirely or can be cut at the apertures 661 at a later time to enable separate processing of the upstream web 631 and the downstream web 633.

Methods of fabricating the glass ribbon 103 with the apparatus 101 that creates a gap between an upstream severed edge and a downstream severed edge will now be described. As shown, in one example, the method can include use of the edge separation apparatus 101a shown in FIG. 1. In addition or alternatively, the method can use an apparatus for severing the glass ribbon.

Referring to the example edge separation apparatus 101a of FIG. 1, one example method can include the step of traversing the glass ribbon 103 in a downward direction 121 relative to the source 105 through the downward zone 123. As shown, the glass ribbon 103 can travel substantially vertically in the downward direction 121 although the downward direction may be angled in further examples wherein the glass ribbon 103 can travel at an inclined orientation in the downward direction. Also, if the glass ribbon 103 is supplied on a roll such as 124, it may also traverse from the roll to the cutting unit in a substantially horizontal direction. For example, the coiled roll 124 and severing zone may exist in nearly the same horizontal plane. In further examples, the roll may be positioned below the horizontal travel plane and unwound horizontally or upwardly to traverse along travel path 112. Similarly, if other methods of making the ribbon are used, for example a float process or an up-draw process, the ribbon may travel in a horizontal, or upward direction as it travels from the forming source to the cutting unit and/or severing zone.

The method can further include the step of bending the glass ribbon 103 in the bending zone 125 downstream from the downward zone 123, wherein the glass ribbon 103 includes the upwardly concave surface 127 through the bending zone 125. As shown, the lower portion 137 can be significantly lower than the bent target segment 151 in the severing zone 147 although the lower portion 137 may be at substantially the same elevation or even higher than the bent target segment in further examples. Providing the lower portion 137 at a significantly lower position, as shown, can develop a predetermined amount of accumulated glass ribbon prior to engaging the support members (e.g., support member 135) of the edge separation apparatus 101a. As such, vibrations or other disturbances upstream from the lower portion 137 may be absorbed by the accumulated glass ribbon within the bending zone. Moreover, the glass ribbon 103 may be drawn at a substantially constant or desired predetermined rate as it passes through the severing zone 147 independent of how fast the glass ribbon 103 is being fed into the downward zone 123 by the source 105. As such, providing an accumulation within the bending zone 125 can allow for further stabilization of the glass ribbon 103 within the severing zone 147 while also allowing the glass ribbon 103 to be passed through the severing zone 147 at a substantially constant or predetermined rate.

If provided, various techniques may be used to help maintain a desired accumulation of glass ribbon 103 within the bending zone 125. For example, a proximity sensor 129 or other device may be able to sense a position of the accumulated ribbon to adjust the rate at which glass ribbon is fed into the downward zone 123 by the source 105 to provide the appropriate accumulation of glass ribbon 103.

In further examples, the method can further include the step of bending the glass ribbon 103 downstream from the bending zone 125 to redirect the glass ribbon to travel in the travel path 112. As shown, the bending support member 135 may include a bent air bar designed to effect the desired change of direction without contacting the central portion 205 of the glass ribbon 103. Furthermore, the method can also include the optional step of orienting the glass ribbon 103 being bent with the bending support member with the lateral guides 143, 145 to help orient the glass ribbon 103 in the correct lateral position relative to the travel path 112 of the glass ribbon 103.

The method can also include the step of traversing the glass ribbon 103 into the severing zone 147 downstream from the bending zone 125 and then bending the glass ribbon 103 in the severing zone 147 to provide the bent target segment 151 with a bent orientation in the severing zone 147.

As shown in FIG. 1, the glass ribbon 103 can be bent such that the bent orientation of the target segment 151 includes the upwardly facing convex surface. In one example, the method can include the step of supporting the bent target segment 151 with the cutting support member 149 comprising the illustrated curved air bar. As shown, the cutting support member 149 can include an upwardly facing convex support surface 152 configured to bend the target segment 151 to establish the upwardly facing convex surface.

As shown in FIG. 1, the method can further include the step of severing at least one of the edge portions 201, 203 from the central portion 205 of the bent target segment 151 within the severing zone 147. As shown in FIG. 3, the examples of the disclosure can include severing both of the edge portions 201, 203 from the central portion 205 although a single edge portion may be severed from the central portion in further examples. Moreover, as shown in FIG. 3, both of the edge portions 201, 203 are severed simultaneously from the central portion 205 although one of the edge portions may be severed before the other edge portion in further examples.

The glass ribbon 103 may include edge beads 207, 209. Alternatively, the glass ribbon 103 may have edge portions 201, 203 that are free from substantial edge beads or features. For example, the edge beads 207, 209 may have been already removed in a previous cutting process or the glass ribbon 103 may have been formed without significant edge bead features. Also, the included figures indicate that the separated edge portions 201, 203 are disposed of or recycled. In another example, the separated edge portions form useable glass ribbon in addition to the central portion 205 and can likewise be either cut into sheets or spooled as product. In this case, multiple cutting operations can exist across the glass ribbon width is it traverses through the cutting unit.

The step of severing can incorporate a wide range of techniques. For example, the edge portions 201, 203 can be severed from the central portion 205 by way of the glass cutting device 153 that can include the illustrated optical delivery apparatus 155 and the coolant fluid delivery apparatus 159.

One example of initiating the severing process can use a scribe or other mechanical device to create an initial defect (e.g., crack, scratch, chip, or other defect) or other surface defect at the site where the glass ribbon is to be severed. The scribe can include a tip although an edge blade or other scribe technique may be used in further examples. Still further, the initial defect or other surface imperfection may be formed by etching, laser impact, or other techniques. The initial defect may be created at the edge of the ribbon or at an inboard location on the ribbon surface.

The initial defect or surface imperfection can be initially formed adjacent a leading edge of the glass ribbon 103 traversing in the travel path 112. As shown in FIG. 3, the elongated radiation zone 227 may be formed on the upwardly facing convex surface. As the elongated radiation zone 227 is elongated in the travel path 112, the radiation heats the region in proximity to the initial defect. The coolant jet 180 then contacts the cooling zone 229 to generate a crack at the initial defect that completely travels through the thickness “T₂” of the glass ribbon 103 due to the created tensile stress to sever the corresponding edge portions 201, 203 from the central portion 205.

The severed opposed edge portions 201, 203 can be effectively removed while leaving the central portion 205 with high quality opposed edges 223, 225 with reduced internal stress profiles, reduced cracks, or other imperfections in the opposed edges 223, 225. As such, the central portion 205 can be bent, such as wound in the storage roll 185 without cracking that may otherwise occur with reduced quality edges. Moreover, the higher quality edges can avoid scratching the central portion 205 during coiling that might otherwise occur with edge portions including glass shards or other imperfections. In addition, the edge portions 201, 203 can likewise be optionally wound on a roll for use in different applications.

The method can further include the step of supporting the bent target segment 151 with the upwardly facing convex surface 152 of the cutting support member 149. For instance, the bent target segment 151 can be supported by the upwardly facing convex surface 152 of the illustrated air bar while severing the edge portions 201, 203 from the central portion 205 of the bent target segment 151 within the severing zone 147.

The method can still further include the step of coiling the central portion 205 of the glass ribbon 103 into the storage roll 185 after the step of severing. As such, the high quality central portion 205 of the glass ribbon may be efficiently coiled into a storage roll 185 for subsequent shipping or processing into glass sheets. As shown in FIGS. 1 and 3, the severed edge portion 201, 203 can be disposed of in a glass ribbon chopper 183 although alternative methodologies may be employed to use the edge portions for other applications. In such examples, one or both of the severed edge portions 201, 203 may be stored on corresponding storage rolls for subsequent processing.

Example methods of severing a glass ribbon 103 across its width, i.e., parallel to the direction of axis 217 will now be described. As shown, the method can begin with providing the source 105 of the glass ribbon 103 with a pair of edge portions 201, 203 that may or may not include the beads 207, 209. Optionally, the edge portions 201, 203 may be severed by way of the procedure discussed above although the edge portions may not be removed in further examples.

As shown, the central portion 205 of the glass ribbon 103 includes a first side 141 facing a first direction and a second side 139 facing a second direction opposite the first direction. In one example, the apparatus 101 can sense the amount of glass ribbon that has been coiled on the storage roll 185 and/or sense a characteristic of the glass ribbon 103 with the monitoring device 193.

If it is determined the glass ribbon should be severed across its width, the electronic controller 195 can activate the device 197, such as the illustrated scribe or other mechanical device, to create an initial defect (e.g., crack, scratch, chip, or other defect) with the point of the scribe to create a controlled and predetermined surface defect at the site where the glass ribbon is to be severed. The scribe can include a tip although an edge blade or other scribe technique may be used in further examples. Still further, the initial defect or other surface imperfection may be formed by etching, laser impact, or other techniques. The initial defect may be created at the edge of the ribbon or at an inboard location on the ribbon surface at a point along the width of the ribbon. In one example, the predetermined surface defect includes a predetermined flaw that is generated by the device 197.

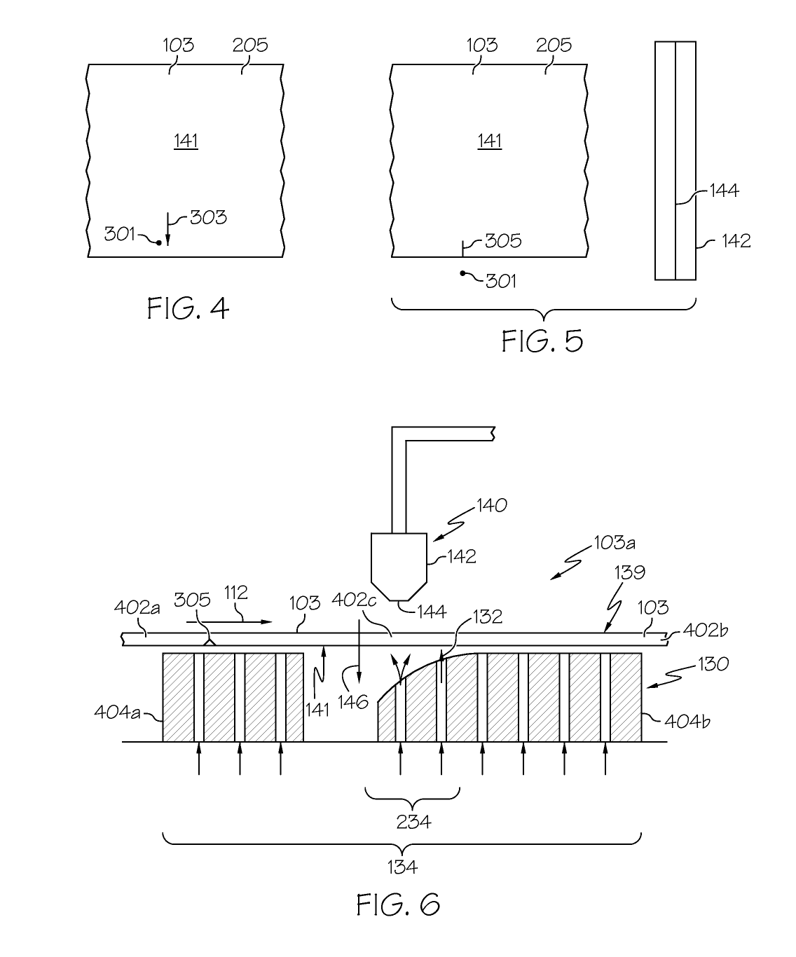

FIG. 4 illustrates the tip 301 engaging the first side 141 and moving in direction 303 to create the predetermined flaw 305 shown in FIG. 5. As shown, in one example, the predetermined flaw 305 can be generated as a linear segment having a length substantially less than a width of the central portion of the glass ribbon defined between the pair of opposed edge portions. In addition or alternatively, the predetermined flaw 305 can be generated as a linear segment extending in a direction of a width of the central portion 205 of the glass ribbon 103 defined between the pair of opposed edge portions. Although not shown, the predetermined flaw 305 can extend across a substantial portion, such as the entire width of the central portion 205. However, as the glass ribbon 103 continues to move in travel path 112, a relatively small segment may be desired to provide a linear segment to control proper severing of the glass ribbon along the width.

FIG. 6 illustrates the portion 103a of the glass ribbon 103 including the predetermined flaw 305 traversing to the severing zone 134 downstream from the source 105 of the glass ribbon 103. As further shown, fluid 132 being emitted from the support member 130 impacts the first side 141 of the glass ribbon 103 to at least partially support a weight of the portion of glass ribbon within the severing zone 134 while maintaining the portion of the glass ribbon in the first orientation. As shown in FIG. 6, the first orientation can substantially provide the glass ribbon along a planar orientation that may be substantially parallel to the travel path 112.

FIG. 7 illustrates the predetermined flaw 305 being traversed farther downstream along travel path 112 wherein the portion 103a of the glass ribbon 103 is temporarily bent in the direction 146 toward the support member 130. The portion 103a can be temporarily bent, for example, by applying a force to the second side 139 of the glass ribbon 103. In one example, a roller may be used to apply a force to the second side 139 of the glass ribbon. Alternatively, as shown, applying the force can be achieved by impacting the second side 139 of the glass ribbon 103 with fluid 401 emitting from the orifice 144 of the nozzle 142. Using a fluid to bend the glass ribbon can be desirable to prevent scratching or otherwise damaging the glass ribbon that may otherwise occur with mechanical contact configurations.

As shown, the portion 103a includes two parallel parts 402a, 402b that extend along the same plane although the two parts 402a, 402b may not be parallel in further examples and/or may extend along different planes. As shown, the orientation of the parts 402a, 402b can be oriented by supporting them with a support member 130. More particularly, the first part 402a can be supported by an upstream support member 404a, and the second part 402b can be supported by a downstream support member 404b. For instance, as shown the support members 404a, 404b can include air bars configured to emit fluid 132, such as gas, to provide respective air cushions. Indeed, the upstream support member 404a can place a first support air cushion between the upstream support member 404a and the first part 402a of the portion 103a of glass ribbon 103. Likewise, the downstream support member 404b can place a second support air cushion between the downstream support member 404b and the second part 402b of the portion 103a of glass ribbon 103. As such, impacting the first side 141 of the glass ribbon 103 with fluid emitting from each of the upstream support member 404a and the downstream support member 404b can provide respective gas cushions that at least partially support a weight of the portion 103a of glass ribbon 103 at respective upstream and downstream positions. Providing support with corresponding air cushions can help position the glass ribbon 103 for severing without touching the pristine surfaces of the glass ribbon. As such, scratching or other damage to the pristine surfaces can be avoided.

As further illustrated in FIG. 7, the portion 103a of the glass ribbon 103 includes a target segment 402c that can be defined between the upstream support member 404a and the downstream support member 404b. As shown in FIG. 6, the upstream support member 404a and the downstream support member 404b can maintain the target segment 402c of the glass ribbon 103 in the first orientation within the severing zone 134 and within the targeted separation region 234. Moreover, as shown, at least a portion of the target segment 402c can be substantially free from support by the gas cushions of the support members 404a, 404b.

As shown in FIG. 7, the method can further include the step of temporarily bending the target segment 402c of the glass ribbon 103 in the direction 146 toward the support member 130 from the first orientation to a severing orientation with a force generated by impacting the second side 139 of the glass ribbon 103 with fluid 401 emitting from the fluid nozzle 142. Optionally, the method can include the step of increasing the rate that fluid is being emitted from at least one of the support members 404a, 404b, such as both support members, to at least partially counteract the force generated by impacting the second side of the glass ribbon with fluid emitting from the fluid nozzle.

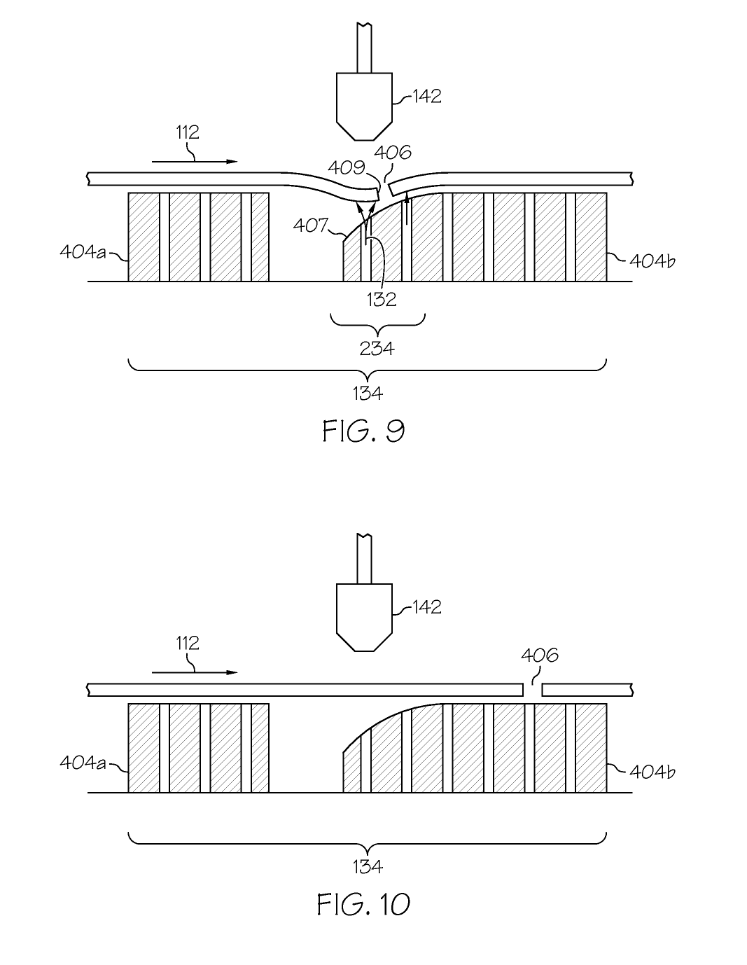

Once bent, the second side 139 has an upwardly concave portion provided between the two parts 402a, 402b of the portion 103a of glass ribbon 103. As such, the lower side of the target segment 402c is placed in tension. FIG. 8 shows the portion 103a further traversing in travel path 112 such that the predetermined flaw 305 enters in the target segment 402c and is placed in tension at a location within the targeted separation region 234 of the severing zone 134. FIG. 9 demonstrates the step of severing the central portion 205 of the glass ribbon 103 between the opposed edge portions at the predetermined flaw 305 located within the severing zone 134. As can be seen from FIGS. 7 and 8, the upwardly concave portion is provided downstream of the predetermined flaw 305. Then, as the glass ribbon 103 travels in the travel path 112, the predetermined flaw 305 travels to the upwardly concave portion, and as it travels through that upwardly concave portion, the glass ribbon 103 is severed across its width at the point of the predetermined flaw 305. It would be difficult, on a traveling ribbon, to form an upwardly concave portion exactly at the predetermined flaw. Accordingly, forming the upwardly concave portion first, and allowing the flaw to travel to that portion facilitates severing the ribbon across its width. Additionally, or alternatively, forming the upwardly concave portion in the targeted separation region 234 of the severing zone 134 and allowing the flaw to travel to the upwardly concave portion eliminates the need for a separate accumulator or stoppage of the glass ribbon 103 in order to sever the glass ribbon 103 across its width.

If there are any constraints in the travel path 112 upon the motion of the glass ribbon 103, they can be controlled during the severing process to allow formation of the curvature that places the lower side of the target segment 402c in tension. If, for example, a set of driven pinch rolls were located near the lateral guides 143, 145, in FIG. 3, the length of the central portion 205 may be influenced. In order to assist bending the glass ribbon 103, relative speed in the travel path 112 between the driven pinch rolls and the downstream take-up device (ex. central core 187 in FIG. 2) can allow for a slight accumulation of length within the severing zone 134.

In addition, the apparatus may include a mechanism to facilitate movement of the glass ribbon along the travel path 112. For example, in some embodiments, the central core 187 may be driven to rotate to help facilitate movement of the glass ribbon 103 along the travel path 112. In addition, or alternatively, a set of drive rollers may facilitate movement of the glass ribbon. Providing a set of drive rollers, for example, can help facilitate movement of the glass ribbon together with the severed end 409 that is no longer connected to the central core 187 after severing. As such, the drive rollers can continue to move the severed end 409 along to be wound on to another central core 187 after switching the storage rolls. The drive rollers can be provided at various locations. For instance, the lateral guides 143, 145 may be provided as driven rollers to help drive the glass ribbon along the travel path 112 although the driven rollers may be provided at alternative locations in further examples.

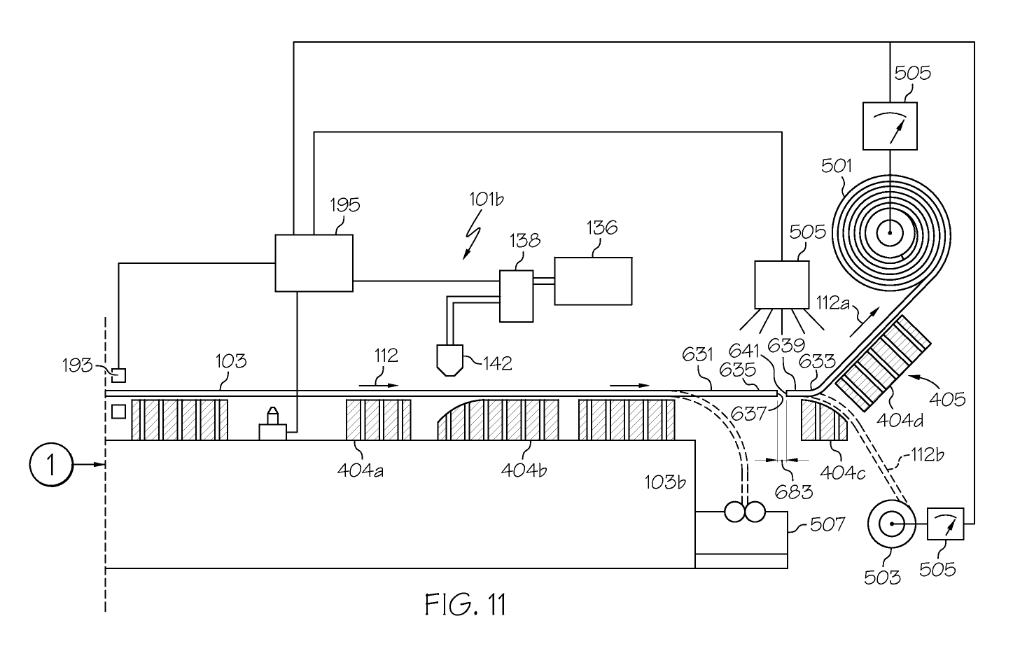

FIGS. 9 and 10 demonstrate the step of returning the target segment 402c of the glass ribbon 103 to the first orientation by removing the force being applied by the fluid nozzle 142. For example, once the flow of fluid from the nozzle is stopped, the flow of fluid from the support member 130 can act against the glass ribbon to restore the glass ribbon to the first orientation, particularly as the severed area 406 travels up into a linear support region of the second support member 404b. As shown, the downstream support member 404b can include a leading end with a convex support surface 407. The convex support surface 407, if provided, can inhibit obstruction of the severed end 409 of the glass ribbon 103 after the step of severing.

As described above, the glass ribbon 103 can be severed by any number of means. After the glass ribbon 103 is severed as shown in FIG. 11, the glass ribbon is separated into an upstream web 631 and a downstream web 633. The upstream web 631 comprises an upstream edge portion 635 including an upstream severed edge 637. The downstream web 633 comprises a downstream edge portion 639 including a downstream severed edge 641. It can be advantageous to create a gap 683 between the upstream web 631 and the downstream web 633. The gap 683 can help facilitate storage roll 501, 503 change without changing the process speed of the apparatus 101. Additionally, the gap 683 can also help reduce or eliminate damage to the glass ribbon 103 created by glass-to-glass contact between the downstream severed edge 641 and the upstream severed edge 637.

FIG. 12 illustrates another contact apparatus 601 wherein the first roller 603 is designed to provide the force to bend the glass ribbon. Providing a roller that rotates can minimize friction and damage to the surface that will likely occur due to the necessary mechanical engagement between the roller and the glass ribbon. Alternatively, driving the first roller 603 to match the speed of the glass ribbon 103 can further reduce friction and damage to the surface. The first roller 603 can bend the glass ribbon temporarily, thereby minimizing the length of glass ribbon that is contacted by the roller. As such, the first roller 603 may only be temporarily moved to bend the glass ribbon shortly before or substantially when the severing is to occur.

FIG. 14 shows the predetermined flaw 305 approaching the severing zone 134 wherein the portion 103a of the glass ribbon 103 including the predetermined flaw 305 in the first orientation. This orientation may be maintained, for example, by the support member 611 configured to emit fluid to contact the first side 141 to provide a support cushion.

FIG. 15 shows the roller 603 being moved in direction 801 to apply a force to the second side 139 of the glass ribbon 103. As shown, the roller 603 rotates while temporarily bending the portion of the glass ribbon in the direction 801 toward the support member 611. In some examples, the air cushion generated by the support member 611 can cause the support member 611 to act against the bias of springs 803 and move in the direction 801 to avoid contacting the glass ribbon 103. As shown in FIG. 13, three spaced support members 611a, 611b, 611c can, in some examples, be independently supported such that the support members 611a, 611b, 611c can each move downward to avoid contacting the glass ribbon when bending the glass ribbon with the roller 603.

As further shown in FIG. 15, once the roller 603 is moved in direction 801, the first side 141 of the glass ribbon 103 can be supported with the second roller 605 and the third roller 607. Indeed, the first side 141 of the glass ribbon 103 can be supported along the support width “S”. As shown, the first roller 603 applies the force to the second side 139 of the glass ribbon 103 along the support width “S” defined between the second roller 605 and the third roller 607. As such, a three point bending configuration may be provided to help bend the ribbon traversing along travel path 112 through a bend similar to the bend illustrated in FIGS. 7 and 8.

Optionally, the endless belt 609 can be provided to rotate with the second roller 605 and the third roller 607 and the endless belt 609 temporarily engages the first side 141 of the glass ribbon 103. Providing the endless belt 609 can help support the portion 103a of the glass ribbon 103 as it traverses through the bend. Moreover, the endless belt 609 can help redirect the severed area 406 through the bend and ultimately back to the first orientation shown in FIG. 14.

As shown in FIG. 13, the endless belt 609 can comprise two or more belts 609a, 609b to provide adequate support across the width “W” of the glass ribbon 103. Pressing the first roller 603 in direction 801 consequently bends the travel path of the endless belt 609 as shown in FIGS. 15 and 16. The belt can be substantially flexible and resilient to allow the belt to stretch to accommodate the increased overall belt length resulting from the bent travel path if the second and third rollers 605, 607 remain at the same spacing relative to one another. Alternatively, as shown, the second and third rollers 605, 607 may be provided with corresponding springs 613a, 613b that allow the second and third rollers 605, 607 to be biased together, against the force of the springs, in corresponding directions 615a, 615b. In such an example, the overall length of the endless belt 609 may remain substantially the same, wherein the second and third rollers 605, 607 move toward each other to accommodate the bend of the travel path.

Once the portion 103a of the glass ribbon 103 is severed along the predetermined flaw 305, the first roller 603 can be retracted such that the first, second and third rollers do not apply a force to the glass ribbon and the gas cushions from the support member 611 can again maintain the portion of the glass ribbon in the first orientation as shown in FIG. 14. Consequently, the springs 613a, 613b, if provided, can bias the second and third rollers 605, 607 away from one another such that the upper segment of the endless belt again achieves the linear profile illustrated in FIG. 14. Moreover, as the portion 103a is repositioned from the bent orientation to the first orientation, the springs 803 again bias the portion 103a to be positioned above, and out of contact with the endless belt 609. As such, as shown in FIG. 14, the endless belt 609 does not engage the glass ribbon 103 in the first orientation. Rather, the air cushion provided by the support member 611 can be designed to provide the necessary support to the glass ribbon to maintain the first orientation.

It will therefore be appreciated that the roller 603 can provide temporary bending of the portion 103a of the glass ribbon including the predetermined flaw 305 for a brief period of time. As such, bending can be achieved to the extent necessary to sever the glass ribbon at the predetermined flaw 305. Moreover, the first orientation may be achieved shortly after severing, wherein the glass ribbon is again supported without mechanically engaging objects that may otherwise scratch or otherwise damage the glass ribbon.

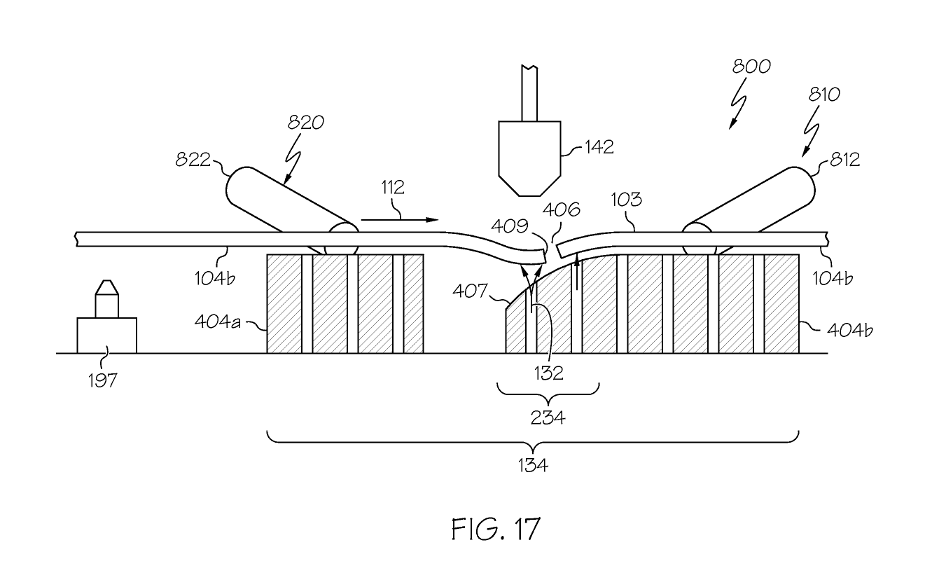

Referring now to FIG. 17, one example of a severing zone 134 of an apparatus 101 for separating glass ribbon 103 is depicted. In this embodiment, the device 197 for introducing a flaw into the glass ribbon 103 is positioned upstream of the severing zone 134 such that as the glass ribbon 103 traverses along the travel path 112, the glass ribbon passes the device 197 and subsequently into the severing zone 134. The apparatus 101 also includes a device 140 for severing the glass ribbon 103. It should be understood that any device for severing the glass ribbon 103 may be incorporated into the apparatus of the instant disclosure.

The apparatus 101 also includes a separation detection apparatus 800 that is positioned proximate to the glass ribbon 103, and may replace or supplement a sensor 509 in the apparatus 101 (as depicted in FIG. 11). In the embodiment depicted in FIG. 17, the separation detection apparatus 800 includes a transmitter 810 and a receiver 820 that are positioned in the travel path 112 relative to one another, where both the transmitter 810 and the receiver 820 are arranged proximate to glass ribbon 103 to transmit or receive a signal from the glass ribbon 103, respectively. In the depicted embodiment, the transmitter 810 and the receiver 820 are arranged to be spaced along the length of the glass ribbon 103 to encompass the position at which the glass ribbon 103 is expected to separate at the severed area 406.

When the apparatus 101 separates the glass ribbon 103 into discrete portions of glass ribbon 103, the separation detection apparatus 800 may detect whether the glass ribbon 103 has been separated. Upon confirmation of separation, operation of the components of the apparatus 101 (for example, the first and second air bar 188, 190 as shown in FIG. 1) may be modified so that the discrete portions of the glass ribbon 103 may be selectively diverted from a first roll to a second roll. If the separation detection apparatus 800 detects that no separation of the glass ribbon 103 has occurred following a flaw generating operation by the device 197, the separation detection apparatus 800 may delay operation of components of the apparatus 101 to maintain the direction of travel of the glass ribbon 103, and prevent the glass ribbon 103 from being diverted from traveling towards the first roll to the second roll.

In the embodiment depicted in FIG. 17, the separation detection apparatus 800 includes an acoustic transmitter 812 that is positioned proximate to the glass ribbon 103 and an acoustic receiver 822 that is positioned proximate to the glass ribbon 103. In one embodiment, the acoustic transmitter 812 and the acoustic receiver 822 may be an air coupled acoustic transmitter 812 or an air coupled acoustic receiver 822, for example air coupled transducers. In one embodiment, the acoustic receiver 822 may be an optical detector, a laser interferometer, or a laser vibrometer, as conventionally known. As depicted in FIG. 17, the acoustic transmitter 812 and the acoustic receiver 822 may be positioned within the severing zone 134 and opposite the targeted separation region 234, such that the acoustic transmitter 812 and the acoustic receiver 822 are positioned opposite the severed area 406 of the glass ribbon 103 from one another. Once the device 197 is commanded to initiate a flaw into the glass ribbon 103, the acoustic transmitter 812 may begin transmitting an acoustic signal into the glass ribbon 103. Because of the properties of the glass ribbon 103, the acoustic signal may propagate along the glass ribbon 103. The acoustic receiver 822 may sense the acoustic signal that was previously transmitted by the acoustic transmitter 812 and propagated along the glass ribbon 103. Sensing of the transmitted acoustic signal by the acoustic receiver 822 may confirm that the glass ribbon 103 has not been separated into discrete portions of glass ribbon 103 at locations between the acoustic transmitter 812 and the acoustic receiver 822. Conversely, failure to sense the transmitted acoustic signal by the acoustic receiver 822 may confirm that the glass ribbon 103 has been separated into discrete portions of glass ribbon 103 at a location between the acoustic transmitter 812 and the acoustic receiver 822. Confirmation of separation of the glass ribbon 103 may trigger the components of the apparatus 101 to be modified in position to direct the severed end 409 of the upstream portion 104b of the glass ribbon 103 towards a second roll for collection and away from a first roll to which the downstream portion 104a glass ribbon is directed for collection.

In some embodiments, the location of the severed area 406 of the glass ribbon 103 may be assumed to be located at a pre-determined position. The apparatus 101 may, through evaluation of the speeds of the downstream portion 104a of the glass ribbon 103 and the upstream portion 104b of the glass ribbon 103, approximate the location of the severed end 409 of the upstream portion 104b of the glass ribbon 103 in the severing zone 134. By approximating the location of the severed end 409, steering components of the apparatus 101 may be maintained in position, thereby continuing to direct the downstream portion 104a of the glass ribbon 103 towards the first roll for collection. When the position of the severed end 409 of the upstream portion 104b of the glass ribbon 103 reaches a pre-determined position, the steering components of the apparatus 101 may be modified to direct the upstream portion 104b of the glass ribbon 103 towards the second roll for collection.

In one embodiment, a guided Lamb (plate) wave may be introduced by the acoustic transmitter. In one embodiment, the acoustic transmitter and the acoustic receiver may be air-coupled transducers. The acoustic signal may be introduced by a pulse-receiver, for example, the Panametrics 5072PR. In some embodiments, the acoustic signal may be transmitted in an ultrasonic frequency range. In some embodiments, the acoustic signal may be transmitted in a sonic frequency range. Presence of the propagated acoustic signal may also be sensed with an oscilloscope.

Without being bound by theory, a Lamb wave is a dispersive ultrasonic wave that propagates in a medium between two parallel surfaces. Lamb waves are formed by interference of multiple reflections and mode conversion of longitudinal waves and shear waves at the free surfaces of the plate. At the outset, Lamb waves behave differently than longitudinal and shear waves. Lamb waves are made up of two groups of waves: symmetric waves and anti-symmetric waves. Each of the symmetric wave and anti-symmetric waves satisfy the wave equations and boundary conditions for thin plates and each can propagate along the plate independently of one another. At low frequencies, two fundamental modes, S0 mode, which corresponds to symmetric waves, and A0 mode, which corresponds to anti-symmetric waves, exist. In S0 mode, the normal displacement at the free boundaries is generally symmetric with respect to the midline of the plate. In the A0 mode, the normal displacement is anti-symmetric with respect to the midline of the plate. In low frequency ranges, the A0 mode is easily generated and detected using air-coupled transducers, because the surface motion of the Lamb wave is largely out-of-plane. In contrast, the S0 mode has mainly in-plane surface displacement, making excitation of the plate difficult. Therefore, for the purposes of generating and detecting a traveling wave in a glass sheet, the A0 mode may be selected.

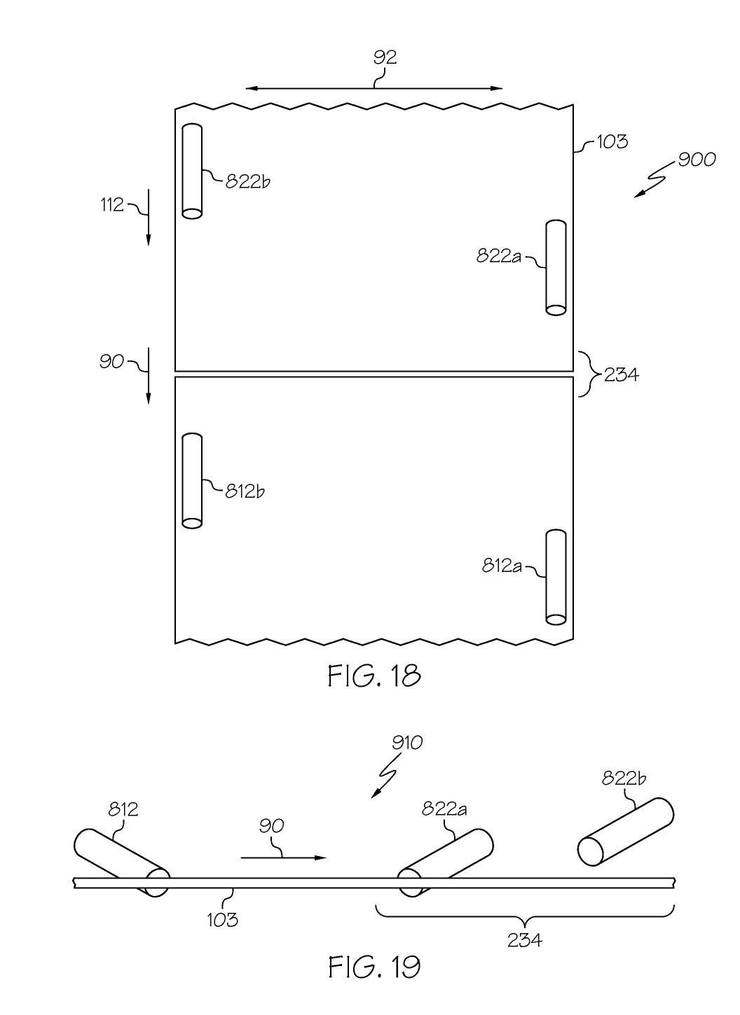

Certain ultrasonic transmitters and receivers may use selective excitation and reception of a particular Lamb wave mode to the increase the signal-to-noise of the detected wave. A phase velocity of both the S0 and the A0 mode of the guided Lamb wave may be estimated based on material properties of the subject plate medium and evaluated at a plurality of points based on the frequency-thickness of the subject plate medium, which is the product of the frequency of the signal and the thickness of the subject plate medium. An example of the phase velocity of the S0 and the A0 modes of a guided Lamb wave that travels through a glass plate having a Young's modulus of 71.7 GPa, a Poisson's ratio of 0.3, and a density of 2200 kg/m³ is shown in FIG. 18 for a series of frequency-thicknesses. Such dispersion curves corresponding to guided Lamb waves modes may be calculated numerically using DISPERSE software package available from the Imperial College of London.

The dispersion curves compare the phase velocity of the guided Lamb wave modes to the frequency-thickness of the plate medium through which the guided Lamb wave travels. As discussed hereinabove, the A0 mode may be selected based on the ease of detection in the subject plate medium. To maximize the signal-to-noise ratio of the guided Lamb wave, the transmitter and receiver transducers, which introduce and detect the guided Lamb wave, respectively, may be positioned at incidence angles α relative to top or bottom surface of the subject plate medium. Selection of the incidence angles α of the transmitter and receiver transducers may be selected to satisfy the Snell-Descartes law:

α=sin⁻¹(V_{c}/Vₘ),

where V_{c} is the wave velocity in the air, and Vₘ is the phase velocity of the A0 mode of the guided Lamb wave through the subject plate medium. A plot of incidence angles α relative to the frequency-thickness of the subject plate medium is also depicted in FIG. 18.

In one example, a transmitting transducer operating at 200 kHz may introduce an acoustic wave into a glass plate having a thickness of 0.7 mm, such that the frequency-thickness of the system is 0.14 MHz-mm Based on the dispersion curves depicted in FIG. 18, the phase velocity of the A0 mode travelling through the glass plate would be about 1.2 km/s, which corresponds to an incidence angle α of about 17.7°. In another example, a transmitter operating at 200 kHz may introduce an acoustic wave into a glass plate having a thickness of 0.2 mm, such that the frequency-thickness of the system is 0.04 MHz-mm. Based on the dispersion curves depicted in FIG. 18, the phase velocity of the A0 mode travelling through the glass plate would be about 0.7 km/s, which corresponds to an incidence angle α of about 33°.

Positioning of the transmitter and the receiver transducers at the incidence angles α relative to the top surface or the bottom surface of the subject plate medium may maximize the signal-to-noise ratio at the receiver transducers, such that detection of the guided Lamb wave at distal positions along the subject plate medium may be maximized.

The transmitting transducers may introduce an acoustic signal to the glass ribbon that is in a range from about 20 kHz to about 5 MHz, including being in a range from about 100 kHz to about 2 MHz, including being in a range from about 200 kHz to about 1 MHz.

Because the glass ribbon 103 may be considered to be a good acoustic waveguide, such waves may be propagated over long distances. Accordingly, the distance between the acoustic transmitter 812 and the acoustic receiver 822 may be modified based on the requirements of a particular end-user application and based on regions of access to the glass ribbon 103. In one example, the acoustic transmitter 812 and the acoustic receiver 822 were positioned distances from 0.8 m to 1.2 m apart from one another. The response amplitude evaluated at the acoustic receiver 822 had a sufficiently high signal-to-noise ratio to recognize when separation of the glass ribbon 103 had occurred. Further, because the acoustic transmitter 812 and the acoustic receiver 822 may be positioned far away from one another, the acoustic transmitter 812 and the acoustic receiver 822 may be positioned to bracket the expected location of the severed area 406 in the severing zone 134. Note that in some instances, the relative timing between when the acoustic signal is transmitted to the time that the acoustic signal is detected may vary based on the relative path length of the glass ribbon 103 evaluated between the acoustic transmitter 812 and the acoustic receiver 822. This may occur, for example, when the glass ribbon 103 passes through a contact apparatus 601 that includes a first roller 603, a second roller 605, and a third roller 607, as depicted in FIG. 12.

In another embodiment (not shown), the break detection apparatus of the glass separating apparatus 101 may include an acoustic receiver 822 that senses a pre-determined acoustic signal associated with separation of the glass ribbon 103. The acoustic receiver 822 may be positioned proximate to the glass ribbon 103 at positions upstream or downstream of the expected location of the severed area 406. Upon sensing of the pre-determined acoustic signal, separation of the glass ribbon 103 may be confirmed.

In yet another embodiment (not shown), the break detection apparatus may include an optical detector. The optical detector may use a high-frequency non-contact displacement measurement technique to detect the vibration associated with separation of the glass ribbon. Similar to the acoustic detection method described immediately above, separation of the glass ribbon may be associated with a pre-determined vibratory pattern, which the optical detector may detect to confirm separation of the glass ribbon 103. In some of these embodiments, a light source may be directed onto a surface of the glass ribbon and an optical detector is positioned above the surface of the glass ribbon to detect light from the light source reflected from the glass ribbon. Vibrations in the glass alter the light reflected from the surface, creating an optical signature indicative of a break or pending break. To detect such a break, the light signal received by the detector may be compared to a calibrated break signal stored in an electronic control unit communicatively coupled to the detector. When a match between the received signal and the calibrated break signal is determined, the electronic control unit outputs a separation event signal indicative of a break in the glass ribbon. Alternatively, the electronic control unit communicatively coupled to the detector may be used to detected temporal variations in the output signal from the detector to identify anomalies which indicate the presence of a break or separation.

In yet another embodiment (not shown), the break detection apparatus may include a visual detection system (including, for example, a digital imaging sensor) that detects and recognizes a visual break or failure to break of the glass ribbon following defect initiation by the glass cutting device and propagation by the severing device.

In yet another embodiment (not shown), the break detection apparatus may include at least one laser detector. The laser detector may sense the edge location of the glass ribbon, including the presence of the severed area and the severed end of the downstream portion 104a and upstream portion 104b of the glass ribbon, respectively. Examples of such laser detectors include laser interferometers or laser vibrometer, as conventionally know. In some of these embodiments, a laser source may be used to direct a laser spot onto the surface of the ribbon in a specific geometric configuration depending on the type of measurement. A detector is positioned to image the spot on the surface of the glass and monitor changes in the optical signal based on vibrations and the motion of the glass ribbon. A break in the web will result in a detectable change in the laser signal received by the detector. Several possible arrangements are possible for the laser. In one embodiment, the laser spot is directed at an angle that creates specular reflection of the laser light back into the detector. A break in the glass ribbon results in a loss of the signal into the detector which is recorded by an electronic control unit communicatively coupled to the detector. In another embodiment, a detector is positioned on the opposite side of the glass ribbon from the laser source so that an edge, such as an edge created by a break in the glass ribbon, passes between the laser source and the detector, scattering the laser light and causing a measurable change in the optical signal detected by the detector. An electronic control unit coupled to the detector may be programmed to monitor the signal output from the detector and identify changes in the signal indicative of a break or separation in the glass ribbon.

Referring now to FIG. 18, another embodiment of a separation detection apparatus 900 is depicted. In this embodiment, the separation detection apparatus 900 includes a first acoustic transmitter 812a that is positioned proximate to the glass ribbon 103 and arranged in a first direction relative to the targeted separation region 234 and a first acoustic receiver 822a that is positioned proximate to the glass ribbon 103 and arranged in a second direction relative to the targeted separation region 234 that is opposite the first direction. The separation detection apparatus 900 also includes a second acoustic transmitter 812b that is positioned proximate to the glass ribbon 103 and arranged in a first direction relative to the targeted separation region 234 and a second acoustic receiver 822b that is positioned proximate to the glass ribbon 103 and arranged in a second direction relative to the targeted separation region 234 that is opposite the first direction. The second acoustic transmitter 812b and the second acoustic receiver 822b are spaced apart from the first acoustic transmitter 812a and the first acoustic receiver 822a in a lateral direction 92 of the glass ribbon 103 that is generally orthogonal to the downstream direction 90 that the glass ribbon 103 is conveyed along the travel path 112.

Incorporation of a first and a second set of acoustic transmitters and receivers may allow for the detection of complete or partial separation of the glass ribbon 103 within the targeted separation region 234. In some embodiments in which the glass ribbon 103 is partially separated, the Lamb wave may be detected across one set of transmitters and receivers and the Lamb wave may not be detected across the opposite set of transmitters and receivers. The partially transmission and detection of the Lamb wave may indicate that the glass ribbon 103 is separated proximate to locations where the Lamb wave is not detected and that the glass ribbon 103 is not separated proximate to locations where the Lamb wave is detected. In some embodiments, the Lamb wave may be pulsed at different time intervals across the first and second pair of transmitters and receivers, so that the position of the separation of the glass ribbon 103 in the lateral direction 92 can be determined. In other embodiments, the distance between the transmitter and the receiver can be varied between the first and second set of the transmitters and receivers, such that the time delay between the transmission of the Lamb wave and the detection of the Lamb wave by the receiver will indicate which of the sets of transmitters and receivers is detecting a signal and which is not, due to separation of the glass ribbon 103.

Referring now to FIG. 19, another embodiment of a separation detection apparatus 900 is depicted. In this embodiment, the separation detection apparatus 910 includes an acoustic transmitter 812 that is positioned proximate to the glass ribbon 103 and arranged in a first direction relative to the targeted separation region 234. The separation detection apparatus 910 also includes a first acoustic receiver 822a and a second acoustic receiver 822b that are both positioned in a second direction relative to the targeted separation region 234 that is opposite from the first direction. The first acoustic receiver 822a and the second acoustic receiver 822b may each detect the presence of the Lamb wave that is introduced to the glass ribbon 103. The first acoustic receiver 822a and the second acoustic receiver 822b may individually detect when the Lamb wave that was introduced by the acoustic transmitter 812 is no longer detectable by the first acoustic receiver 822a but detectable by the second acoustic receiver 822b, thereby providing an indication of the location of the separation of the glass ribbon 103 as the glass ribbon 103 is directed in the downstream direction 90.

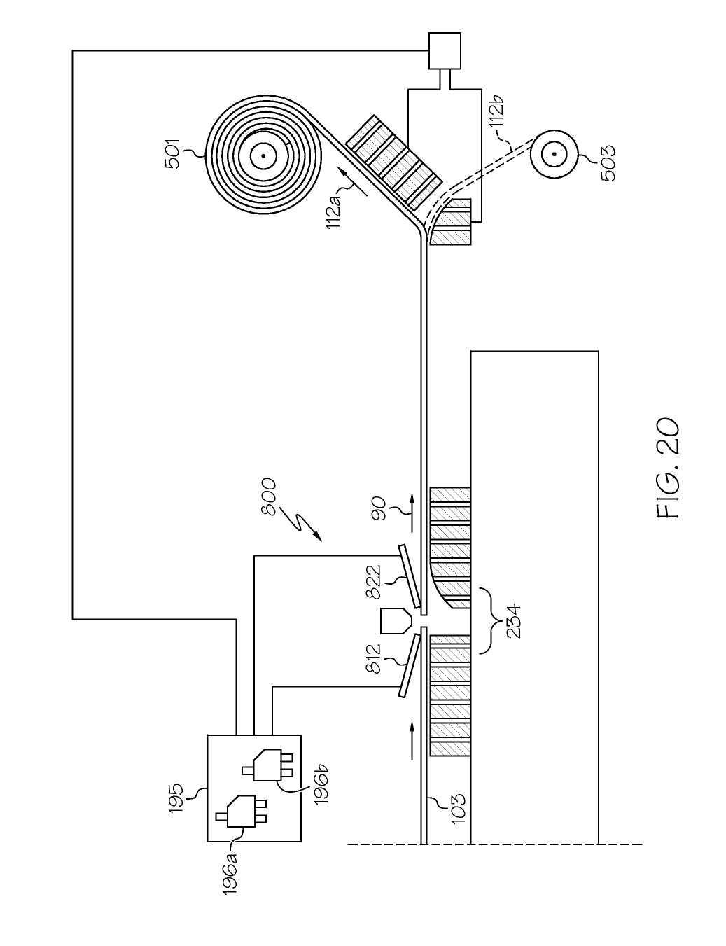

Referring now to FIG. 20, an embodiment of the apparatus 101 is depicted. Similar to embodiments discussed above, the apparatus 101 includes a separation detection apparatus 800 that is one of the manufacturing components that are arranged within the apparatus 101 along the travel path 112 of the glass ribbon 103. The separation detection apparatus 800 is electronically coupled to an electronic controller 195. The electronic controller 195 includes a processor 196a and a memory 196b that is electronically coupled to the processor. A computer readable instruction set may be stored in the memory 196b of the electronic controller 195 and may be operable to control the manufacturing components of the apparatus 101 when executed by the processor 196a of the electronic controller 195. The electronic controller 195 may be electronically coupled to the components of the separation detection apparatus 800, including the acoustic transmitter 812 and the acoustic receiver 822. In one embodiment, the electronic controller 195 may be a programmable logic controller (PLC), as conventionally known. The computer readable instruction set that is stored within the electronic controller 195 may be programmed to perform a series of operations to modify operation of the manufacturing components of the apparatus 101 prior to, during, and after separation of the glass ribbon 103, as detected by the separation detection apparatus 800.

In one embodiment, the electronic controller 195 initiates separation of the glass ribbon 103 into a downstream portion and an upstream portion with the glass cutting device 153. The electronic controller 195 may also provide commands to the separation detection apparatus 800 to introduce an acoustic wave into the glass ribbon 103 with the acoustic transmitter 812. The acoustic receiver 822 may provide an output signal to the electronic controller 195 that indicates whether the acoustic wave propagated by the acoustic transmitter 812 has been received by the acoustic receiver 822. Based on the output signal that is provided by the acoustic receiver 822, the electronic controller 195 may determine if the glass ribbon 103 has separated into an upstream portion and a downstream portion by evaluating when the acoustic receiver 822 fails to receive the acoustic wave that was propagated by the acoustic transmitter 812. Upon confirmation of separation of the glass ribbon 103, the electronic controller 195 modifies a setting of a manufacturing component that is positioned downstream of the targeted separation region 234 at a time subsequent to determining that the glass ribbon 103 has separated. In one example, the electronic controller 195 may modify operation of components of a steering element (as discussed hereinabove) that is positioned in the downstream direction from the targeted separation region 234. Operation of the steering element may modify the conveyance direction of the glass ribbon 103 such that the glass ribbon 103 moves from following a first exiting travel path 112a toward a first storage roll 501 to a second exiting travel path 112b toward a second storage roll 503. Manufacturing operations that occurring in the downstream direction 90 from the targeted separation region 234 can therefore be selected subsequent to confirmation of separation of the glass ribbon 103. Such positive confirmation of separation of the glass ribbon 103 may improve manufacturability of the glass ribbon 103.

### Examples

A single-sided inspection setup was installed in the field for an on-line feasibility study. A pair of air-coupled transducers manufactured by NCU Ultran group were used in all the experiments in the report. The transducers are unfocused PZT transducers with a central frequency of 200 KHz and a circular aperture diameter of 1″. Experiments were conducted in pitch catch mode in which one transducer behaves as transmitter while another behaves as a receiver. The air-coupled transmitter was located above one side of a glass ribbon, mounted on the optical stages, and orientated roughly at an angle for A0 mode Lamb wave detection. The air-coupled receiver was positioned at the same side of the glass ribbon and was further adjusted to get an orientation of the probes optimized for a maximum signal. Optical stages holding the transducers were mounted on the aluminum extrusions frame above the conveying glass which has a thickness of 0.2 mm. The transducers were orientated at an angle of 33°, which was selected for A0 mode Lamb wave generation and detection in the tested glass ribbon. The distance between the transducer was about 0.6 m.

The air-coupled transducer was excited with electrical spike of 500V by a pulser-receiver (PR 5072, Panametrics Inc.) which emits ultrasound into the air. The ultrasonic wave transmitted to the glass ribbon and then was mode converted into the Lamb wave. Part of the Lamb wave leaked energy into the surrounding air and was captured by the receiver air-coupled transducer. The received signal was then amplified and acquired by a digital oscilloscope.

When spool rolling was in process, the vertical distance from the transducers to the glass was about 80 mm. As the roll changing started, the moving glass ribbon and the underlying supporting air bearing elements below the cutting laser were lifted and the laser was turned on. The vertical distance from the transducers to the glass ribbon was reduced to about 30 mm. After the glass separation finished by the laser, the air bars and the glass ribbon returned to the original height.

Detection of the A0 mode Lamb wave was made throughout the roll changing process. The Lamb wave was detected at an earlier time when the air bars lifted the glass ribbon prior to performance of a laser cut to separate the glass ribbon. A shorter gap between the glass ribbon and the transducers accounts for the time shift in detection of the A0 mode Lamb wave. Following separation of the glass ribbon, the gap between adjacent portions of the glass ribbon interrupts the Lamb wave from being propagated along the glass ribbon. The A0 mode Lamb wave was undetected following

The time of receipt of the detected A0 mode Lamb wave shifted in during the roll changing process. The Lamb wave arrived at an earlier time when the air bars lifted in preparation of a laser cut of the glass ribbon. The shift in the time phase of the Lamb wave is due to a shorter air gap between the transducers and the glass. When the glass ribbon was separated, the crack blocks the propagation of the Lamb wave in the glass ribbon, and no Lamb wave was detected. The lack of detection of the Lamb wave at a position opposite the location of separation of the glass ribbon was confirmed to indicate separation of the glass ribbon.

Incorporation of break detection apparatuses according to the present disclosure may result in improvements of the production efficiency of glass manufactured in a continuous-draw process, as described hereinabove. In particular, the incorporation of break detection apparatuses may eliminate operator-indicated separation detection of the glass ribbon. Further, the ability to automate the separation detection may allow for a quicker response of components of the formation apparatus, including triggering repositioning of the relevant steering components of the formation apparatus to selectively steer the glass ribbon between two spools. The break detection apparatuses may also minimize glass-to-glass contact during and after the separation operation, thereby minimizing potential damage to the downstream portion and the upstream portion of the glass ribbon. The break detection apparatus may also facilitate improved roll-to-roll change threading. Any and all of these improvements may result in more robust processing on glass ribbon that is drawn from the formation apparatus, resulting in reduced product loss, increased cost savings and reduced down time. Incorporation of break detection apparatuses may also result in increased production efficiency and reduced lead times for product deliveries to customers along the supply chain.

It should now be understood that apparatuses for separating glass ribbon according to the present disclosure may incorporate a break detection apparatus positioned proximate to the severing zone of the glass processing apparatus. The break detection apparatus may include one of a variety of sensors that are adapted to determine if separation of the glass ribbon has occurred. In one embodiment, the glass detection apparatus includes an acoustic transmitter that introduces an acoustic signal to the glass ribbon. When the acoustic signal is detected by an acoustic receiver positioned opposite the expected severing area of the glass ribbon from the transmitter, the glass ribbon has not been separated. When the acoustic signal is transmitted by the acoustic transmitter but not sensed by the acoustic receiver, separation of the glass ribbon within the severing zone is confirmed.

It will be apparent to those skilled in the art that various modifications and variations can be made without departing from the spirit and scope of the claimed disclosure.

What is claimed is:

1. An apparatus for severing glass ribbon comprising:
a plurality of manufacturing components arranged into a travel path;
a glass cutting device;
a severing zone positioned in a downstream direction from the glass cutting device, the severing zone comprising a targeted separation region along the travel path;
an acoustic transmitter positioned in a first direction from the targeted separation region;
an acoustic receiver positioned in a second direction from the targeted separation region opposite the first direction; and
a manufacturing component positioned along the travel path in the downstream direction from the targeted separation region.

2. The apparatus for severing glass ribbon of claim 1, wherein the acoustic transmitter comprises an air coupled acoustic transducer.

3. The apparatus for severing glass ribbon of claim 1, wherein the acoustic receiver comprises an air coupled acoustic transducer.

4. The apparatus for severing glass ribbon of claim 1, wherein the acoustic receiver comprises an optical detector.

5. The apparatus for severing glass ribbon of claim 1, wherein the acoustic receiver comprises a laser interferometer or a laser vibrometer.

6. The apparatus for severing glass ribbon of claim 1, wherein the acoustic receiver comprises a mechanical detector coupled to a contact apparatus positioned in the severing zone.

7. The apparatus for severing glass ribbon of claim 1, further comprising an electronic controller comprising a processor and a memory storing a computer readable instruction set that, when executed by the processor:
initiates separation of the glass ribbon into a downstream portion and an upstream portion with the glass cutting device;
introduces an acoustic wave into the glass ribbon with the acoustic transmitter;
receives the acoustic wave from the glass ribbon with the acoustic receiver;
determines if the glass ribbon has separated into the upstream portion and the downstream portion when the acoustic receiver fails to receive the acoustic wave from the acoustic transmitter; and
modifies a setting of the manufacturing component that is positioned downstream of the targeted separation region at a time subsequent to determining that the glass ribbon has separated.

8. The apparatus for severing glass ribbon of claim 7, wherein the manufacturing component that is positioned downstream of the targeted separation region comprises a steering element that selectively directs the glass ribbon along a first exiting travel path to a first storage roll or a second exiting travel path to a second storage roll.

9. The apparatus for severing glass ribbon of claim 1, further comprising a second acoustic transmitter and a second acoustic receiver positioned proximate to the targeted separation region and spaced apart in a lateral direction of the glass ribbon from the acoustic transmitter and the acoustic receiver.

10. The apparatus for severing glass ribbon of claim 1, further comprising a second acoustic receiver positioned proximate to the travel path and in the second direction from the targeted separation region.

11. A method of separating a glass ribbon comprising:
traversing the glass ribbon along a travel path past a glass cutting device and through a severing zone and along a travel direction after exiting the severing zone;
introducing an acoustic wave into the glass ribbon with an acoustic transmitter positioned in a first direction from the severing zone;
detecting a presence of the acoustic wave in the glass ribbon with an acoustic receiver positioned in a second direction from the severing zone that is opposite the first direction;
inducing separation of the glass ribbon with the glass cutting device into an upstream portion and a downstream portion;
detecting separation of the glass ribbon in the severing zone when the acoustic wave that was introduced to the glass ribbon is interrupted at the acoustic receiver; and
modifying a conveyance direction of the glass ribbon toward a manufacturing component that is positioned in a downstream direction from the severing zone subsequent to detection of separation of the glass ribbon.

12. The method of claim 11, wherein the acoustic transmitter comprises an air coupled acoustic transducer.

13. The method of claim 11, wherein the acoustic receiver comprises an air coupled acoustic receiver.

14. The method of claim 11, wherein modification of the conveyance direction of the glass ribbon is suspended if separation of the glass ribbon is interrupted.

15. The method of claim 11, wherein the acoustic wave comprises a guided Lamb wave.

16. The method of claim 11, wherein the acoustic wave is pulsed at intervals by the acoustic transmitter.

17. The method of claim 11, wherein the acoustic wave is at a frequency in a range from about 20 kHz to about 5 MHz.

18. The method of claim 11, wherein the acoustic wave is at a frequency in a range from about 200 kHz to about 1 MHz.

19. The method of claim 11, further comprising:
introducing a second acoustic wave in the glass ribbon with a second acoustic transmitter;
detecting a presence of the second acoustic wave in the glass ribbon with a second acoustic receiver; and
detecting complete separation of the glass ribbon in the severing zone with the acoustic wave is interrupted at the acoustic receiver and the second acoustic wave is interrupted at the second acoustic receiver,
wherein the second acoustic transmitter and the second acoustic receiver are positioned proximate to the severing zone and spaced apart in a lateral direction of the glass ribbon from the acoustic transmitter and the acoustic receiver.
